(19) United States
(12) Patent Application Publication
(10) Pub. No.: US 2023/0267302 A1
(43) Pub. Date: Aug. 24, 2023

(54) Large-Scale Architecture Search in Graph Neural Networks via Synthetic Data

(71) Applicant: Google LLC, Mountain View, CA (US)

(72) Inventors: Bryan Thomas Perozzi, Cranford, NJ (US); Anton Tsitsulin, Moscow (RU); John Joseph Palowitch, San Francisco, CA (US); Brandon Mayer, New York, NY (US)

(21) Appl. No.: 17/940,568

(22) Filed: Sep. 8, 2022

Related U.S. Application Data
(63) Continuation of application No. PCT/RU2022/000051, filed on Feb. 18, 2022.

(51) Int. Cl. G06N 3/04; G06N 3/08

(52) U.S. Cl. CPC G06N 3/04; G06N 3/08

(57) ABSTRACT

Systems and methods for graph model search and/or for architecture insight can include training and testing a plurality of graph models. For example, the systems and methods can generate a plurality of synthetic graph datasets, which can then be utilized to train a plurality of graph models with varying graph model architectures. The trained graph models can then be evaluated based on outputs generated by the models based on test inputs. The evaluation data can then be utilized for providing particular graph model insight and/or may be utilized to enable task-specific graph model search.

### FIELD

The present disclosure relates generally to graph model training and evaluation. More particularly, the present disclosure relates to generating a plurality of synthetic graph datasets, training a plurality of graph models, and generating evaluation data based on outputs from the trained graph models, which can be utilized to infer parameters for future use of models on unseen data.

### BACKGROUND

The selection of a graph model for a particular task can be difficult. Furthermore, learning the strengths and weaknesses of particular graph models can be difficult. Additionally, the supply of training datasets can be limited. Even for the evaluations that utilize larger training datasets, the reporting of the outcomes may be limited to only a small subset of the output data.

In particular, despite advances in the field of Graph Neural Networks (GLANS), only a very small number (˜5) of datasets are currently used to evaluate new models. This can be fundamentally limiting, as any one graph dataset may provide limited insight into a GNN's performance characteristics. Furthermore, the limited set of evaluation graphs may be chosen primarily for convenience and may not be representative of the underlying distribution of graphs available on the web.

While there has been work on improving and standardizing GNN benchmark datasets, relying only on a handful of graph datasets over time is detrimental to the field, for the following three reasons: inadequate generalization, incremental overfitting, and un-scalable development. For inadequate generalization, each curated graph dataset may represent just one point in the space of all possible datasets that can be associated with the particular GNN task at-hand. Therefore, the graph (or graphs) in a particular dataset may have properties that favor some GNN models over others; however, yet-unseen graphs may have different characteristics that could reverse any insights made from the singular trial. For incremental overfitting, GNN task datasets may be successively re-used across papers, to accurately measure incremental improvements of new architectures. This can cause overfitting of new architectures to the datasets, as can be observed for NLP tasks and computer vision tasks. For un-scalable development, there may have been a particular focus on scalability in GNN research. However, with large benchmark datasets, it can be difficult to investigate GNN hyperparameter tuning techniques or training variance without access to institution-scale computing resources.

### SUMMARY

Aspects and advantages of embodiments of the present disclosure will be set forth in part in the following description, or can be learned from the description, or can be learned through practice of the embodiments.

One example aspect of the present disclosure is directed to a computing system. The system can include one or more processors and one or more non-transitory computer-readable media that collectively store instructions that, when executed by the one or more processors, cause the computing system to perform operations. The operations can include generating, by one or more generators, a plurality of synthetic graph datasets. In some implementations, the plurality of synthetic graph datasets can include structured-graph data. The operations can include training a plurality of graph models with at least a subset of the plurality of synthetic graph datasets to generate a plurality of trained graph models. The operations can include processing one or more inputs from the plurality of synthetic graph datasets with the plurality of trained graph models to generate a plurality of graph outputs. In some implementations, the operations can include determining a particular graph model of the plurality of graph models based on a comparison between the plurality of graph outputs and storing data associated with the particular graph model.

In some implementations, the operations can include generating an evaluation representation associated with the plurality of graph models based on the plurality of graph outputs and providing the evaluation representation for display. Each of the plurality of synthetic graph datasets can include a realization of a parameterized probability distribution. In some implementations, each of the plurality of synthetic graph datasets can include one or more training graphs, one or more training features, and one or more training labels. The one or more generators can include one or more attributed-graph generators. In some implementations, the one or more generators can include one or more label generators. Each of the plurality of graph models can include a graph neural network. The subset of the plurality of synthetic graph datasets and the one or more inputs from the plurality of synthetic graph datasets can differ.

In some implementations, the operations can include obtaining, from a user computing device, a user-input graph model and training the user-input graph model with a first synthetic graph dataset of the plurality of synthetic graph datasets to generate a first trained graph model. The operations can include training the user-input graph model with a second synthetic graph dataset of the plurality of synthetic graph datasets to generate a second trained graph model and processing a test portion of the plurality of synthetic graph datasets with the first trained graph model to generate a plurality of first user-model outputs. In some implementations, the operations can include processing the test portion of the plurality of synthetic graph dataset with the second trained graph model to generate a plurality of second user-model outputs and comparing the plurality of first user-model outputs and plurality of second user-model outputs.

In some implementations, the operations can include generating evaluation data based at least in part on the plurality of first user-model outputs and plurality of second user-model outputs and providing the evaluation data to the user computing device. The operations can include generating comparison data based on the plurality of first user-model outputs, the plurality of second user-model outputs, and the plurality of graph outputs and providing the comparison data to the user computing device.

In some implementations, the operations can include obtaining input data associated with a specific task. Training the plurality of graph models with at least the subset of the plurality of synthetic graph datasets to generate the plurality of trained graph models can include training the plurality of graph models to perform the specific task. The plurality of synthetic graph datasets can be generated based on the input data, and the plurality of synthetic graph datasets can include a plurality of labels associated with the specific task.

Training the plurality of graph models with at least the subset of the plurality of synthetic graph datasets to generate the plurality of trained graph models can include training a first graph model of the plurality of graph models with a first synthetic graph dataset of the plurality of synthetic graph datasets to generate a first trained graph model and training a first graph model of the plurality of graph models with a second synthetic graph dataset of the plurality of synthetic graph datasets to generate a second trained graph model. Training the plurality of graph models with at least the subset of the plurality of synthetic graph datasets to generate the plurality of trained graph models can include training a second graph model of the plurality of graph models with a first synthetic graph dataset of the plurality of synthetic graph datasets to generate a third trained graph model and training a second graph model of the plurality of graph models with a second synthetic graph dataset of the plurality of synthetic graph datasets to generate a fourth trained graph model. In some implementations, the plurality of trained graph models can include the first trained graph model, the second trained graph model, the third trained graph model, and the fourth trained graph model.

Another example aspect of the present disclosure is directed to a computer-implemented method. The method can include generating, by a computing system including one or more processors, a plurality of synthetic graph datasets. In some implementations, the plurality of synthetic graph datasets can include structured-graph data. The method can include training, by the computing system, a plurality of graph models with at least a subset of the plurality of synthetic graph datasets to generate a plurality of trained graph models. The method can include processing, by the computing system, one or more inputs from the plurality of synthetic graph datasets with the plurality of trained graph models to generate a plurality of graph outputs. In some implementations, the method can include generating, by the computing system, an evaluation representation associated with the plurality of graph models based on the plurality of graph outputs and providing, by the computing system, the evaluation representation for display.

In some implementations, the evaluation representation can include evaluation data descriptive of node classification for the plurality of graph models. The evaluation representation can include evaluation data descriptive of link prediction for the plurality of graph models.

Another example aspect of the present disclosure is directed to one or more non-transitory computer-readable media that collectively store instructions that, when executed by one or more computing devices, cause the one or more computing devices, cause the one or more computing devices to perform operations. The operations can include obtaining input data associated with a user. The operations can include generating, by one or more generators, a plurality of synthetic graph datasets based at least in part on the input data. In some implementations, the plurality of synthetic graph datasets can include structured-graph data. The operations can include training a plurality of graph models with at least a subset of the plurality of synthetic graph datasets to generate a plurality of trained graph models. The operations can include processing one or more inputs from the plurality of synthetic graph datasets with the plurality of trained graph models to generate a plurality of graph outputs. In some implementations, the operations can include generating an output representation associated with the plurality of graph models based on the plurality of graph outputs. The operations can include providing the output representation for display.

In some implementations, the output representation can include a graphical depiction of a feature center distance based on the plurality of graph outputs associated with the plurality of graph models. The output representation can include vector graph statistic data and hyperparameter evaluation data.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1A depicts a block diagram of an example computing system that performs graph model training and testing according to example embodiments of the present disclosure.

FIG. 1B depicts a block diagram of an example computing device that performs graph model training and testing according to example embodiments of the present disclosure.

FIG. 1C depicts a block diagram of an example computing device that performs graph model training and testing according to example embodiments of the present disclosure.

FIG. 2 depicts a block diagram of an example graph model generator and evaluator system according to example embodiments of the present disclosure.

FIG. 3 depicts a block diagram of an example graph model generator and evaluator system according to example embodiments of the present disclosure.

FIG. 4 depicts a block diagram of an example graph world flow according to example embodiments of the present disclosure.

FIG. 5 depicts an illustration of an example distribution of graphs according to example embodiments of the present disclosure.

FIG. 6 depicts a flow chart diagram of an example method to perform graph model training and testing according to example embodiments of the present disclosure.

FIG. 7 depicts a flow chart diagram of an example method to perform graph model training and testing according to example embodiments of the present disclosure.

FIG. 8 depicts a flow chart diagram of an example method to perform graph model training and testing according to example embodiments of the present disclosure.

FIG. 9 depicts a block diagram of an example graph model training and testing according to example embodiments of the present disclosure.

FIG. 10 depicts an illustration of example node classification datasets according to example embodiments of the present disclosure.

FIG. 11 depicts an illustration of example node classification results according to example embodiments of the present disclosure.

FIG. 12 depicts an illustration of example link prediction results according to example embodiments of the present disclosure.

FIG. 13 depicts an illustration of example hyperparameter tuning results according to example embodiments of the present disclosure.

FIG. 14 depicts a flow chart diagram of an example method to perform architecture search according to example embodiments of the present disclosure.

Reference numerals that are repeated across plural figures are intended to identify the same features in various implementations.

### DETAILED DESCRIPTION

### Overview

Generally, the present disclosure is directed to systems and methods for graph neural network search and evaluation. For example, the systems and methods disclosed herein can generate and/or obtain a plurality of synthetic graph datasets, which can be utilized to evaluate a plurality of graph models. In some implementations, the graph models can include a graph neural network. The evaluation can be utilized to determine which graph models can be utilized for different tasks. The evaluation can be stored and can then be utilized to provide a searchable database to find architectures and/or models that excel for different tasks.

In some implementations, the systems and methods can include generating, by one or more attributed-graph generators and one or more label generators, a plurality of synthetic graph datasets. Each of the plurality of synthetic graph datasets can include a realization of a parameterized probability distribution, and each of the plurality of synthetic graph datasets may include one or more training graphs, one or more training features, and one or more training labels. The systems and methods can include processing one or more subsets of the plurality of synthetic graph datasets with a plurality of graph models to generate a plurality of graph outputs. In some implementations, each of the plurality of graph models can include a graph neural network. A particular graph model of the plurality of graph models can be determined based on a comparison between the plurality of graph outputs. The particular graph model can then be stored and/or utilized for a task.

Additionally and/or alternatively, the generation of the plurality of synthesized graph datasets can be facilitated by, or determined by, a manager block that can provide one or more worker generators with regions of generator parameters based on a user input. The worker generators can then each generate a single realization by sampling a generator parameter set and then by sampling a single dataset from a domain.

In some implementations, the systems and methods can generate a plurality of synthetic graph datasets using one or more generators. The plurality of synthetic graph datasets can include structured-graph data (e.g., knowledge graphs, world wide web data, and/or social network data). In some implementations, each of the plurality of synthetic graph datasets can include a realization of a parameterized probability distribution. Additionally and/or alternatively, each of the plurality of synthetic graph datasets may include one or more training graphs, one or more training features, and/or one or more training labels.

The generation of the plurality of synthetic graph datasets can be configured to generate input datasets (e.g., input datasets with graphs and features) with diverse structural characteristics. In some implementations, the diverse generation can involve the sampling of graphs and features from a database. Alternatively and/or additionally, the space of possible datasets can be deterministically selected to encompass a diverse representation.

The synthetic graph dataset generation may be conditioned based on one or more inputs. The inputs can include a list of models and associated hyperparameter spaces, a task formulation (e.g., a space of possible datasets, and/or a probability distribution), a task metric (e.g., a test accuracy function), and/or a number of datasets to sample on the graph world.

In some implementations, the one or more generators can include one or more attributed-graph generators. Additionally and/or alternatively, the one or more generators can include one or more label generators. Moreover, in some implementations, plurality of synthetic graph datasets can be generated based on the input data. The plurality of synthetic graph datasets can include a plurality of labels associated with the specific task.

Alternatively and/or additionally, the systems and methods can utilize a manager and worker structure. The manager generator can divide the domain of possible hyperparameters into regions for the worker generators to sample. The worker generators can then generate hyperparameter inputs by sampling their respective region assigned by the manager.

The systems and methods can include obtaining a plurality of graph models. In some implementations, the plurality of graph models can be obtained from a database and/or may be generated using one or more model configurators. In some implementations, the plurality of graph models can include a diverse selection of graph models (e.g., ARMA, AAPNP, FiLM, GAT, GATv2, GCN, GIN, GraphSAGE, SGC, etc.).

The plurality of graph models can then be trained with at least a subset of the plurality of synthetic graph datasets to generate a plurality of trained graph models. In some implementations, each of the plurality of graph models can include a graph neural network. The models can be trained with a wide variety of hyper-parameters and architectures.

Additionally and/or alternatively, training the plurality of graph models with at least the subset of the plurality of synthetic graph datasets to generate the plurality of trained graph models can include training a first graph model of the plurality of graph models with a first synthetic graph dataset of the plurality of synthetic graph datasets to generate a first trained graph model. Training can include training a first graph model of the plurality of graph models with a second synthetic graph dataset of the plurality of synthetic graph datasets to generate a second trained graph model. Moreover, training can further include training a second graph model of the plurality of graph models with a first synthetic graph dataset of the plurality of synthetic graph datasets to generate a third trained graph model and training a second graph model of the plurality of graph models with a second synthetic graph dataset of the plurality of synthetic graph datasets to generate a fourth trained graph model. The plurality of trained graph models can include the first trained graph model, the second trained graph model, the third trained graph model, and the fourth trained graph model. Therefore, in some implementations, a first output, a second output, a third output, and a fourth output can be generated based on the first trained graph model, the second trained graph model, the third trained graph model, and the fourth trained graph model. The first output, the second output, the third output, and the fourth output can be utilized to evaluate the trained models. The evaluation may be utilized to determine the strengths and weaknesses of each particular model.

Additionally and/or alternatively, one or more inputs from the plurality of synthetic graph datasets can be processed with the plurality of trained graph models to generate a plurality of graph outputs. In some implementations, the subset of the plurality of synthetic graph datasets and the one or more inputs from the plurality of synthetic graph datasets may differ.

The one or more inputs can be selected by randomly searching the plurality of synthetic graph datasets to determine representative inputs for testing the models.

In some implementations, one or more vectors of metrics can be computed for each graph output. The vector graph statistics and highest scoring hyperparameters can then be utilized to generate an architecture prediction function.

Additionally and/or alternatively, the systems and methods can automatically find input data characteristics which may be determined as interesting based on a divergence in performance between models. In some implementations, the divergence can be determined based on statistical divergences in the outputs of trained models.

A particular graph model of the plurality of graph models can be determined based on a comparison between the plurality of graph outputs. For example, the particular graph model can be determined based on a comparison between the output of the particular graph model and a ground truth output. The respective output of the particular graph model may be the output of the plurality of outputs that has the highest similarity score to the ground truth output.

Additionally and/or alternatively, data associated with the particular graph model can be stored. The particular graph model can be stored with the data associated with a particular training dataset, evaluation data, and/or the generated output(s).

In some implementations, the systems and methods disclosed herein can include generating an evaluation representation associated with the plurality of graph models based on the plurality of graph outputs. The evaluation representation can include one or more graphical representations descriptive of performance of the plurality of trained graph models.

Additionally and/or alternatively, the systems and methods can provide the evaluation representation for display. In some implementations, the evaluation representation can be provided via a graphical user interface.

Alternatively and/or additionally, the systems and methods can utilize the results of the training and testing to automatically suggest hyper-parameters and model architecture for new and/or unseen datasets as they arrive in practice. In some implementations, the data associated with the trained models, the training dataset, and their test outputs can be stored and may be searchable for future use. The stored data can be stored with one or more indicators indicating strengths and/or weaknesses of the different hyper-parameters and model architectures. In some implementations, the systems and methods can include mapping between the characteristics of the graph input data, the model architecture, and the hyper-parameter choices to each model's performance. The systems and methods may learn a regression over this input description vector and descriptions of the best fit models (i.e., hyper-parameters) in order to predict which hyper-parameters and architectures to use on new datasets.

In some implementations, the systems and methods can be further utilized to evaluate a user-input graph model generated or provided by the user via one or more inputs. For example, the systems and methods can include obtaining, from a user computing device, a user-input graph model.

The systems and methods can include training the user-input graph model with a first synthetic graph dataset of the plurality of synthetic graph datasets to generate a first trained graph model. Additionally and/or alternatively, the systems and methods can include training the user-input graph model with a second synthetic graph dataset of the plurality of synthetic graph datasets to generate a second trained graph model. A test portion of the plurality of synthetic graph datasets can be processed with the first trained graph model to generate a plurality of first user-model outputs. Additionally and/or alternatively, the test portion of the plurality of synthetic graph dataset can be processed with the second trained graph model to generate a plurality of second user-model outputs.

The plurality of first user-model outputs and plurality of second user-model outputs can then be compared. For example, evaluation data can be generated based at least in part on the plurality of first user-model outputs and plurality of second user-model outputs. The evaluation data can then be provided to the user computing device.

Additionally and/or alternatively, the systems and methods can include generating comparison data based on the plurality of first user-model outputs, the plurality of second user-model outputs, and the plurality of graph outputs. The comparison data can then be provided to the user computing device.

In some implementations, the systems and methods can train and evaluate graph models for a particular task. For example, the systems and methods can obtain input data associated with a specific task. Training the plurality of graph models with at least the subset of the plurality of synthetic graph datasets to generate the plurality of trained graph models can include training the plurality of graph models to perform the specific task.

Alternatively and/or additionally, the systems and methods disclosed herein can provide an evaluation representation as output. The evaluation representation can provide data for the user to understand the strengths and weaknesses of each respective graph model. For example, the systems and methods can include generating a plurality of synthetic graph datasets. The plurality of synthetic graph datasets can include structured-graph data. The plurality of synthetic graph datasets can be utilized to train to generate a plurality of trained graph models. In some implementations, one or more inputs from the plurality of synthetic graph datasets can be processed with the plurality of trained graph models to generate a plurality of graph outputs. The plurality of graph outputs can be utilized to generate an evaluation representation associated with the plurality of graph models. The systems and methods can then provide the evaluation representation for display.

In some implementations, the systems and methods disclosed herein can include obtaining input data associated with a user.

Additionally and/or alternatively, the systems and methods can include generating a plurality of synthetic graph datasets. The plurality of synthetic graph datasets can include structured-graph data. The plurality of synthetic graph datasets can be generated based at least in part on the input data. Additionally and/or alternatively, the plurality of synthetic graph datasets can be generated using one or more generators.

A plurality of graph models can be trained with a subset of the plurality of synthetic graph datasets to generate a plurality of trained graph models.

In some implementations, one or more inputs from the plurality of synthetic graph datasets can be processed with the plurality of trained graph models to generate a plurality of graph outputs.

Additionally and/or alternatively, an output representation (e.g., an evaluation representation) associated with the plurality of graph models can be generated based on the plurality of graph outputs. In some implementations, the evaluation representation can include evaluation data descriptive of node classification for the plurality of graph models. The evaluation representation may include evaluation data descriptive of link prediction for the plurality of graph models.

Alternatively and/or additionally, the output representation can include a graphical depiction of a feature center distance based on the plurality of graph outputs associated with the plurality of graph models. In some implementations, the output representation can include vector graph statistic data and hyperparameter evaluation data.

The output representation can then be provided for display. The output representation can be provided via a graphical user interface and may be depicted as a table, chart, graph, and/or textual summary.

In some implementations, the plurality of synthetic graph datasets can be generated based on task specific inputs. Additionally and/or alternatively, the trained and evaluated graph models can be indexed based on determined strengths and/or weaknesses.

The systems and methods can perform the models training and testing for each instance of user input. Alternatively and/or additionally, the training and testing data for each model may be stored. The stored data can then be accessed to compare against newly trained and tested models. The stored data can include the specific graph models, their hyperparameters, and/or their training data.

Additionally and/or alternatively, the systems and methods disclosed herein can involve one or more interactions with a user interface by a user. For example, a user may interact with a user interface of a web application, a localized application, a web service, etc. to learn more about a set of data and/or learn more about a set of graph models. The user can access the user interface using a computing device. The user computing device can communicate with a server computing system via a network to access the graph world system. The user can then select a set of data to be used for testing, select one or more graphs to test, and/or select a task to test the graph model architectures and hyperparameters.

For example, a user can provide, or transmit, input data (e.g., selection data) to the graph world system via one or more inputs to the user interface. Based on the one or more inputs, the graph world computing system can train a plurality of graph models based at least in part on the input data. The trained graph models can be evaluated to generate evaluation data. The evaluation data can then be received by the user via the user computing device. The evaluation data can be provided via the user interface. The evaluation data can be received as a structured representation descriptive of the evaluation data. For example, the user can receive a graphical representation of the evaluation data via a table, one or more bar graphs, one or more line graphs, one or more scatter plots, etc.

In some implementations, the input data can be descriptive of a particular region of possible test/training data space to sample from when training and/or testing the graph models. Alternatively and/or additionally, the input data can be descriptive of a particular graph model to train and test. Alternatively and/or additionally, the input data can be descriptive of a task to evaluate the graph models on during evaluation. Therefore, the evaluation data generated and received can be descriptive of graph model architectures and hyperparameters performance for that particular task.

The systems and methods disclosed herein can be utilized for training and evaluating graph model architectures and hyperparameters for a variety of different tasks (e.g., graph classification, node classification, link prediction, etc.).

Based on the evaluation data, a user can select, or the system can determine, a particular graph model architecture and/or hyperparameters to utilize for one or more uses. For example, based on the evaluation data, a graph model can be chosen for drug discovery (e.g., by utilizing learned effects of a drug and determined connections between biological symptoms and effective cures), statistical prediction, sensory prediction (e.g., olfactory prediction, taste prediction, sound prediction, etc.), social network predictions or determinations (e.g., for determining the relevance of certain individuals information to another person based on determined relationships, hierarchies, etc.), web link prediction, molecular data prediction or determination, geography prediction or determination, and/or a variety of other uses. Additionally and/or alternatively, the models can be trained and evaluated to determine object trajectories in a space based on the learned dynamics of a system. In some implementations, the systems and methods can be utilized to train and evaluate graph models for text classification and/or image classification by utilizing generated graphs from preprocessing of the text and/or images. The text classification can be utilized to determine a next word or phrase to include in a generated text string. The image classification may be utilized to generate new frames to add to a collection of frames for generating an animated image or video.

The graph models can include graph neural networks for processing structured graph data. In some implementations, the graph models can learn a graph embedding space for relationship determinations.

The systems and methods of the present disclosure provide a number of technical effects and benefits. As one example, the system and methods can train a plurality of graph models with a plurality of synthetic graph datasets. More specifically, the systems and methods disclosed herein can generate a plurality of synthetic graph datasets that can then be utilized for graph model training and testing. Training datasets for graph models can be limited. The systems and methods disclosed herein can leverage the generation of diverse synthetic graph datasets to provide larger and more diverse training datasets. The synthetic graph datasets can allow for the mitigation or elimination of biases and overfitting caused by the use of only a limited training dataset pool.

Another technical benefit of the systems and methods of the present disclosure is the ability to evaluate models with a wide variety of hyper-parameters and architectures. More specifically, the systems and methods can train and evaluate a large number of graph models with varying architectures and hyper-parameters. The output of the evaluations can provide insight on the strengths and weaknesses of different input datasets, which can include training datasets, hyper-parameters, and/or particular architectures. The insight provided can then be utilized to determine a model architecture and hyper-parameters that can achieve a given task with a greatest efficiency. The data related to the trained models and their evaluations can then be stored. The stored data can be searchable and allow for the comparison of different models for future uses.

Another example technical effect and benefit relates to the reduction of computational cost and computational time. The systems and methods disclosed herein can allow for the training, evaluation, and storage of graph models. The graph models can be trained, evaluated, and then stored in a database. The evaluation of the machine-learned models can be stored for reference for future tasks or uses. The storage of the performance data and other data related to the graph models can allow for users to understand the strengths and weaknesses of different model architectures and hyper-parameters without having to retrain the graph models upon each instance of a new task.

With reference now to the Figures, example embodiments of the present disclosure will be discussed in further detail.

### Example Devices and Systems

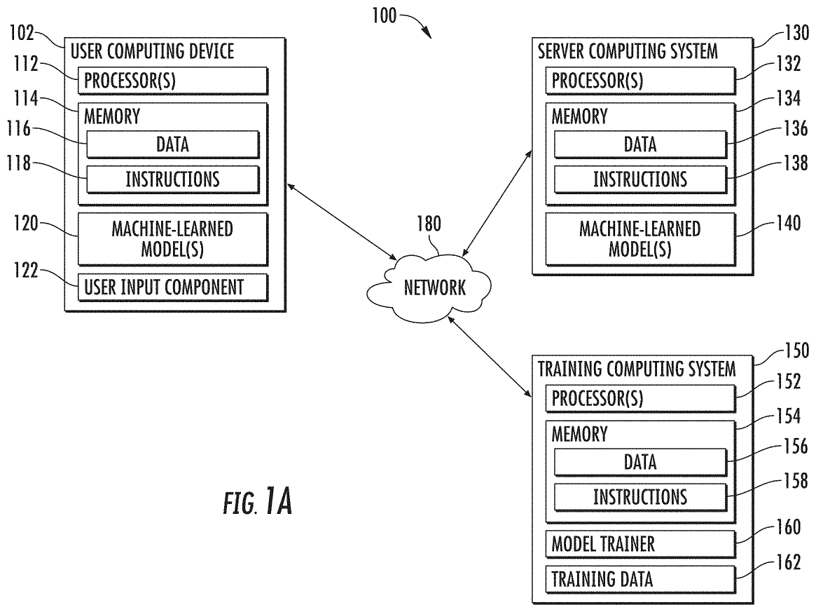

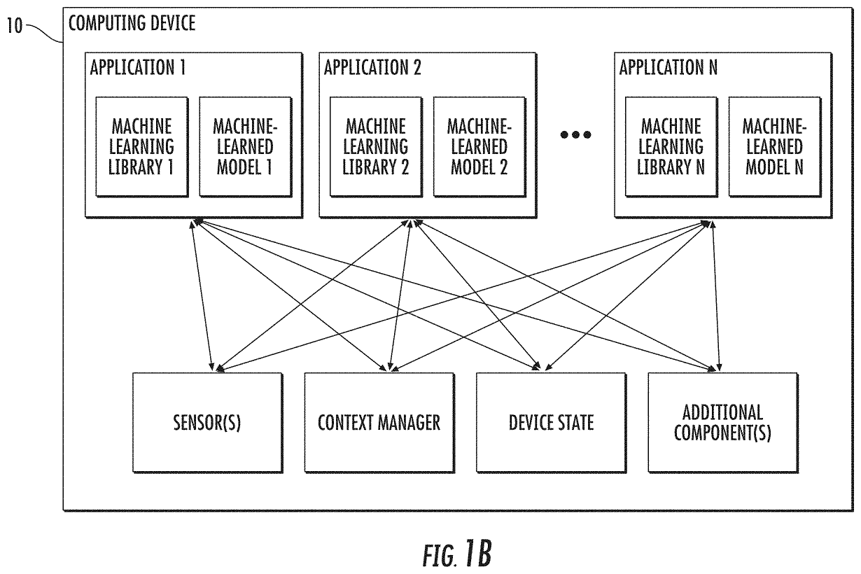

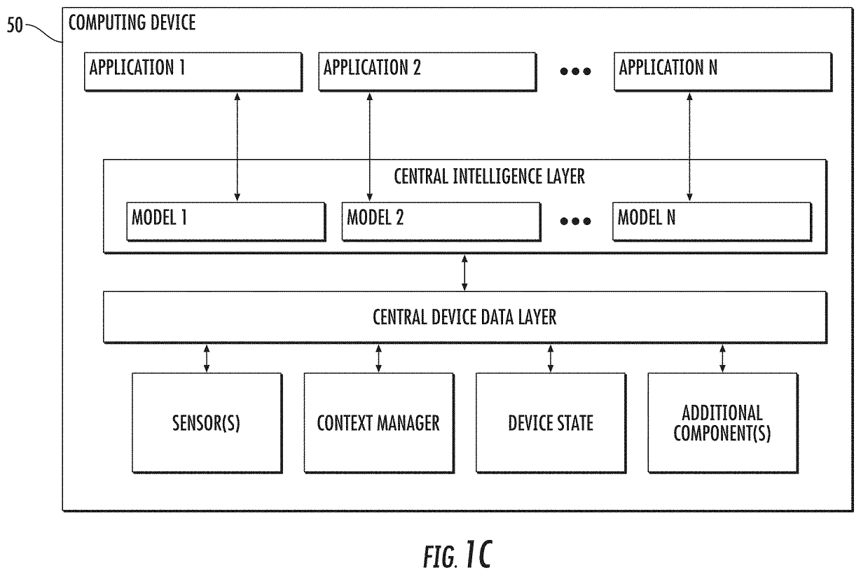

FIG. 1A depicts a block diagram of an example computing system 100 that performs graph model training and testing according to example embodiments of the present disclosure. The system 100 includes a user computing device 102, a server computing system 130, and a training computing system 150 that are communicatively coupled over a network 180.

The user computing device 102 can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing device 102 includes one or more processors 112 and a memory 114. The one or more processors 112 can be any suitable processing device (e.g., a processor core, a microprocessor, an ASIC, a FPGA, a controller, a microcontroller, etc.) and can be one processor or a plurality of processors that are operatively connected. The memory 114 can include one or more non-transitory computer-readable storage mediums, such as RAM, ROM, EEPROM, EPROM, flash memory devices, magnetic disks, etc., and combinations thereof. The memory 114 can store data 116 and instructions 118 which are executed by the processor 112 to cause the user computing device 102 to perform operations.

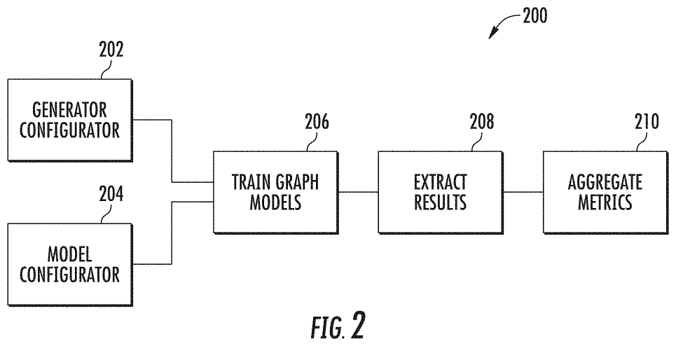

In some implementations, the user computing device 102 can store or include one or more graph world models 120. For example, the graph world models 120 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks. Example graph world models 120 are discussed with reference to FIGS. 2-4.

In some implementations, the one or more graph world models 120 can be received from the server computing system 130 over network 180, stored in the user computing device memory 114, and then used or otherwise implemented by the one or more processors 112. In some implementations, the user computing device 102 can implement multiple parallel instances of a single graph world model 120 (e.g., to perform parallel graph model training and evaluation across multiple instances of graph model architectures and/or hyperparameters).

More particularly, the graph world model can include one or more machine-learned models for generating a plurality of synthetic graph datasets. The graph world model can obtain a plurality of graph models that can then be trained with different subsets of the plurality of synthetic graph datasets. The trained graph models can then be evaluated by processing test data from the plurality of synthetic graph datasets. The outputs of the graph models when processing the test data can be utilized to determine trends and/or differentiators found in the outputs. For example, one graph model configuration (e.g., a particular model architecture and/or a particular set of hyperparameters) may provide more accurate outputs when compared to the other models. The evaluation data can be utilized to provide insight into the strengths and weaknesses of different hyperparameters and architectures. Data associated with the graph models can then be stored for later use (e.g., for model architecture/hyperparameter search and/or for future comparison). Additionally and/or alternatively, the graph world model may generate one or more predictions, or suggestions, based on the evaluation data. The predictions can include particular model hyperparameters and architectures that may be of increased utility for specific tasks and/or for particular datasets.

Additionally or alternatively, one or more graph world models 140 can be included in or otherwise stored and implemented by the server computing system 130 that communicates with the user computing device 102 according to a client-server relationship. For example, the graph world models 140 can be implemented by the server computing system 140 as a portion of a web service (e.g., a graph model search service). Thus, one or more models 120 can be stored and implemented at the user computing device 102 and/or one or more models 140 can be stored and implemented at the server computing system 130.

The user computing device 102 can also include one or more user input component 122 that receives user input. For example, the user input component 122 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The server computing system 130 includes one or more processors 132 and a memory 134. The one or more processors 132 can be any suitable processing device (e.g., a processor core, a microprocessor, an ASIC, a FPGA, a controller, a microcontroller, etc.) and can be one processor or a plurality of processors that are operatively connected. The memory 134 can include one or more non-transitory computer-readable storage mediums, such as RAM, ROM, EEPROM, EPROM, flash memory devices, magnetic disks, etc., and combinations thereof. The memory 134 can store data 136 and instructions 138 which are executed by the processor 132 to cause the server computing system 130 to perform operations.

In some implementations, the server computing system 130 includes or is otherwise implemented by one or more server computing devices. In instances in which the server computing system 130 includes plural server computing devices, such server computing devices can operate according to sequential computing architectures, parallel computing architectures, or some combination thereof.

As described above, the server computing system 130 can store or otherwise include one or more machine-learned graph world models 140. For example, the models 140 can be or can otherwise include various machine-learned models. Example machine-learned models include neural networks or other multi-layer non-linear models. Example neural networks include feed forward neural networks, deep neural networks, recurrent neural networks, and convolutional neural networks. Example models 140 are discussed with reference to FIGS. 2-4.

The user computing device 102 and/or the server computing system 130 can train the models 120 and/or 140 via interaction with the training computing system 150 that is communicatively coupled over the network 180. The training computing system 150 can be separate from the server computing system 130 or can be a portion of the server computing system 130.

The training computing system 150 includes one or more processors 152 and a memory 154. The one or more processors 152 can be any suitable processing device (e.g., a processor core, a microprocessor, an ASIC, a FPGA, a controller, a microcontroller, etc.) and can be one processor or a plurality of processors that are operatively connected. The memory 154 can include one or more non-transitory computer-readable storage mediums, such as RAM, ROM, EEPROM, EPROM, flash memory devices, magnetic disks, etc., and combinations thereof. The memory 154 can store data 156 and instructions 158 which are executed by the processor 152 to cause the training computing system 150 to perform operations. In some implementations, the training computing system 150 includes or is otherwise implemented by one or more server computing devices.

The training computing system 150 can include a model trainer 160 that trains the machine-learned models 120 and/or 140 stored at the user computing device 102 and/or the server computing system 130 using various training or learning techniques, such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations.

In some implementations, performing backwards propagation of errors can include performing truncated backpropagation through time. The model trainer 160 can perform a number of generalization techniques (e.g., weight decays, dropouts, etc.) to improve the generalization capability of the models being trained.

In particular, the model trainer 160 can train the graph world models 120 and/or 140 based on a set of training data 162. The training data 162 can include, for example, structured-graph data generated by one or more generators. The training data 162 can include a plurality of graphs, a plurality of features, and/or a plurality of labels. Additionally and/or alternatively, the training data 162 can include a realization of a parameterized probability distribution over a domain of possible test datasets.

In some implementations, if the user has provided consent, the training examples can be provided by the user computing device 102. Thus, in such implementations, the model 120 provided to the user computing device 102 can be trained by the training computing system 150 on user-specific data received from the user computing device 102. In some instances, this process can be referred to as personalizing the model.

The model trainer 160 includes computer logic utilized to provide desired functionality. The model trainer 160 can be implemented in hardware, firmware, and/or software controlling a general purpose processor. For example, in some implementations, the model trainer 160 includes program files stored on a storage device, loaded into a memory and executed by one or more processors. In other implementations, the model trainer 160 includes one or more sets of computer-executable instructions that are stored in a tangible computer-readable storage medium such as RAM hard disk or optical or magnetic media.

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

The machine-learned models described in this specification may be used in a variety of tasks, applications, and/or use cases.

In some implementations, the input to the machine-learned model(s) of the present disclosure can be structured-graph data. The machine-learned model(s) can process the structured-graph data to generate an output. As an example, the machine-learned model(s) can process the structured-graph data to generate a structured-graph recognition output (e.g., a recognition of the graph data, a latent embedding of the structured-graph data, an encoded representation of the structured-graph data, a hash of the structured-graph data, etc.). As another example, the machine-learned model(s) can process the structured-graph data to generate a structured-graph segmentation output. As another example, the machine-learned model(s) can process the structured-graph data to generate a structured-graph classification output. As another example, the machine-learned model(s) can process the structured-graph data to generate a graph data modification output (e.g., an alteration of the graph data, etc.). As another example, the machine-learned model(s) can process the graph data to generate an encoded graph data output (e.g., an encoded and/or compressed representation of the graph data, etc.). As another example, the machine-learned model(s) can process the structured-graph data to generate an upscaled structured-graph data output. As another example, the machine-learned model(s) can process the graph data to generate a prediction output.

In some implementations, the input to the machine-learned model(s) of the present disclosure can be feature data. The machine-learned model(s) can process the feature data to generate an output. As an example, the machine-learned model(s) can process the feature data to generate a feature output. As another example, the machine-learned model(s) can process the feature data to generate a latent feature embedding output. As another example, the machine-learned model(s) can process the feature data to generate a classification output. As another example, the machine-learned model(s) can process the feature data to generate a feature segmentation output. As another example, the machine-learned model(s) can process the feature data to generate a link prediction output. As another example, the machine-learned model(s) can process the feature data to generate an upscaled feature output (e.g., feature data that is higher quality than the input feature, etc.). As another example, the machine-learned model(s) can process the feature data to generate a prediction output.

In some implementations, the input to the machine-learned model(s) of the present disclosure can be latent encoding data (e.g., a latent space representation of an input, etc.). The machine-learned model(s) can process the latent encoding data to generate an output. As an example, the machine-learned model(s) can process the latent encoding data to generate a recognition output. As another example, the machine-learned model(s) can process the latent encoding data to generate a reconstruction output. As another example, the machine-learned model(s) can process the latent encoding data to generate a search output. As another example, the machine-learned model(s) can process the latent encoding data to generate a reclustering output. As another example, the machine-learned model(s) can process the latent encoding data to generate a prediction output.

In some implementations, the input to the machine-learned model(s) of the present disclosure can be statistical data. The machine-learned model(s) can process the statistical data to generate an output. As an example, the machine-learned model(s) can process the statistical data to generate a recognition output. As another example, the machine-learned model(s) can process the statistical data to generate a prediction output. As another example, the machine-learned model(s) can process the statistical data to generate a classification output. As another example, the machine-learned model(s) can process the statistical data to generate a segmentation output. As another example, the machine-learned model(s) can process the statistical data to generate a segmentation output. As another example, the machine-learned model(s) can process the statistical data to generate a visualization output. As another example, the machine-learned model(s) can process the statistical data to generate a diagnostic output.

In some cases, the machine-learned model(s) can be configured to perform a task that includes encoding input data for reliable and/or efficient transmission or storage (and/or corresponding decoding). In another example, the input includes graph data (e.g., one or more graphs or features), the output comprises compressed graph data, and the task is a graph data compression task. In another example, the task may comprise generating an embedding for input data (e.g., input graph or feature data).

FIG. 1A illustrates one example computing system that can be used to implement the present disclosure. Other computing systems can be used as well. For example, in some implementations, the user computing device 102 can include the model trainer 160 and the training dataset 162. In such implementations, the models 120 can be both trained and used locally at the user computing device 102. In some of such implementations, the user computing device 102 can implement the model trainer 160 to personalize the models 120 based on user-specific data.

FIG. 1B depicts a block diagram of an example computing device 10 that performs according to example embodiments of the present disclosure. The computing device 10 can be a user computing device or a server computing device.

The computing device 10 includes a number of applications (e.g., applications 1 through N). Each application contains its own machine learning library and machine-learned model(s). For example, each application can include a machine-learned model. Example applications include a text messaging application, an email application, a dictation application, a virtual keyboard application, a browser application, etc.

As illustrated in FIG. 1B, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

FIG. 1C depicts a block diagram of an example computing device 50 that performs according to example embodiments of the present disclosure. The computing device 50 can be a user computing device or a server computing device.

The computing device 50 includes a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer includes a number of machine-learned models. For example, as illustrated in FIG. 1C, a respective machine-learned model (e.g., a model) can be provided for each application and managed by the central intelligence layer. In other implementations, two or more applications can share a single machine-learned model. For example, in some implementations, the central intelligence layer can provide a single model (e.g., a single model) for all of the applications. In some implementations, the central intelligence layer is included within or otherwise implemented by an operating system of the computing device 50.

The central intelligence layer can communicate with a central device data layer. The central device data layer can be a centralized repository of data for the computing device 50. As illustrated in FIG. 1C, the central device data layer can communicate with a number of other components of the computing device, such as, for example, one or more sensors, a context manager, a device state component, and/or additional components. In some implementations, the central device data layer can communicate with each device component using an API (e.g., a private API).

### Example Model Arrangements

FIG. 2 depicts a block diagram of an example graph model generator and evaluator system 200 according to example embodiments of the present disclosure. In some implementations, the graph model generator and evaluator system 200 is configured to utilize a generator configurator 202 and a model configurator 204 to generate and/or obtain a plurality of synthetic graph datasets and a plurality of graph models. The plurality of synthetic graph datasets and the plurality of graph models can be utilized to generate a plurality of trained graph models, which can then be tested to extract results 208. The extracted results can then be utilized to generate aggregated metrics 210 representations for providing insight to one or more users.

In particular, FIG. 2 can depict an example graph model generator and evaluator system 200 that includes a graph world model that can generate synthetic data, train machine-learned graph models, evaluate the machine-learned graph models, and generate an output representation based on the evaluation data. The graph model generator and evaluator system 200 can utilize a generator configurator to 202 to facilitate the generation of a plurality of synthetic graph datasets using one or more generators. Additionally and/or alternatively, the graph model generator and evaluator system 200 can utilize a model configurator 204 to generate and/or obtain a plurality of graph models. In some implementations, the graph models can have differing architectures.

The plurality of synthetic graph datasets and the plurality of graph models can be utilized to generate a plurality of trained graph models 206. The plurality of trained graph models can be evaluated using synthetic graph datasets in order to extract results 208 descriptive of the performance of the trained graph models with respect to their respective outputs. The extracted results can be utilized to determine aggregate metrics 210 associated with the performance of the models with respect to each other model. The aggregate metrics 210 can be stored in a database for future use and/or may be utilized to generate one or more output representations descriptive of the trained graph models' respective performances.

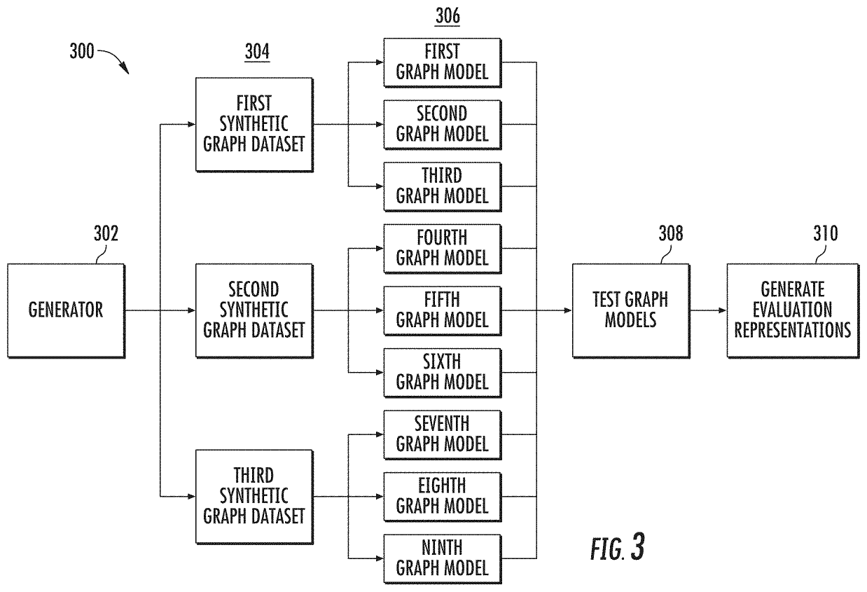

FIG. 3 depicts a block diagram of an example graph model generator and evaluator system 300 according to example embodiments of the present disclosure. The graph model generator and evaluator system 300 is similar to the graph model generator and evaluator system 200 of FIG. 2 except that the graph model generator and evaluator system 300 further includes a more explicit depiction of the branching structure for the generation of trained models.

In particular, FIG. 3 can depict one or more processing steps that can be completed by a machine-learned graph world model. In some implementations, the system 300 can obtain one or more inputs from a user computing device. In response to receiving the one or more inputs, the generator 302 can generate a plurality of graph synthetic datasets 304 (e.g., a first synthetic graph dataset, a second synthetic graph dataset, a third synthetic graph dataset, etc.).

A plurality of graph models can be obtained and trained with the plurality of synthetic graph datasets 304 to generate a plurality of trained graph models 306 (e.g., a first graph model, a second graph model, a third graph model, a fourth graph model, a fifth graph model, a sixth graph model, a seventh graph model, an eighth graph model, ninth graph model etc.). For example, the plurality of graph models can include graph models with a plurality of different GNNs (e.g., three or more different graph neural networks which can include ARMA, APPNP, FiLM, GAT, GATv2, GCN, GIN, GraphSAGE, SGC, etc.). In some implementations, each of the different GNNs can be trained with each respective synthetic graph dataset. For example, the depicted example can include three different synthetic graph datasets and three different GNNs. Therefore, the first synthetic graph dataset can be utilized to train graph models to generate the first graph model, the second graph model, and the third model; the second synthetic graph dataset can be utilized to train graph models to generate the fourth graph model, the fifth graph model, and the sixth model; and the third synthetic graph dataset can be utilized to train graph models to generate the seventh graph model, the eighth graph model, and the ninth model. Additionally and/or alternatively, the first graph model, the fourth graph model, and the seventh graph model can be of a first GNN type (e.g., an ARMA model); the second graph model, the fifth graph model, and the eighth graph model can be of a second GNN type (e.g., an APPNP model); and the third graph model, the sixth graph model, and the ninth graph model can be of a third GNN type (e.g., a FiLM model). Although the example depicted includes three synthetic graph datasets and three GNN model types, the system can include any number of synthetic graph datasets and/or any number of GNN model types.

The plurality of trained graph models 306 can then be tested 308 using one or more synthetic graph datasets. The outputs of the plurality of trained graph models 306 can be aggregated and used to generate one or more evaluation representations 310. The one or more evaluation representations 310 can be descriptive of the performance of each respective trained model based on one or more metrics.

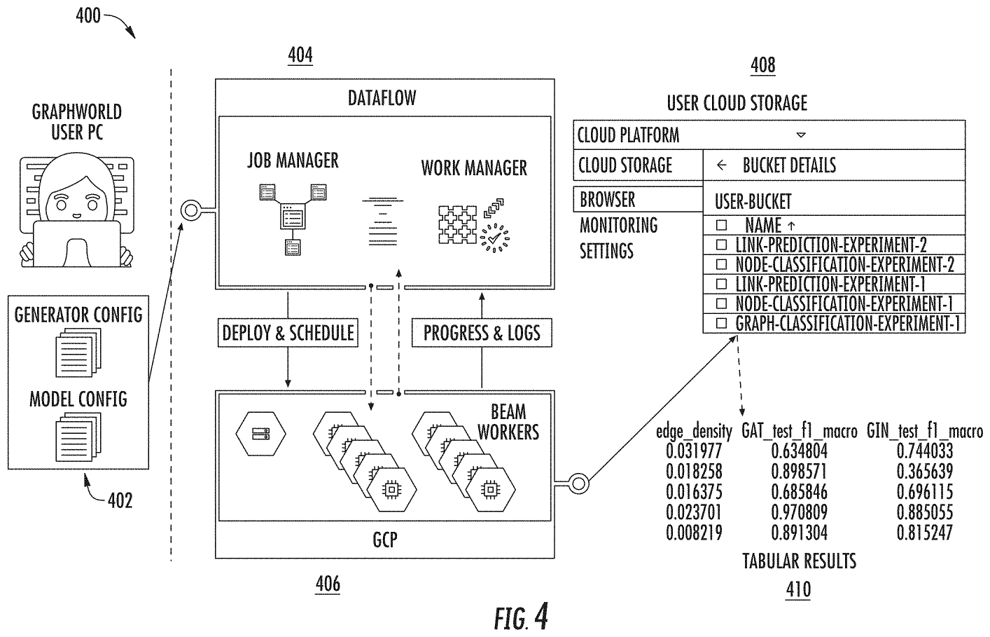

FIG. 4 depicts a block diagram of an example graph world flow according to example embodiments of the present disclosure. In particular, FIG. 4 depicts a user on their PC. The GraphWorld user can specify the generator and model and can then launch a GraphWorld pipeline, which can be submitted on a remote manager. The records of GNN tests can be stored in a cloud storage system, which can then accumulate into a data table via the cloud storage API.

In particular, the graph world flow 400 can involve a user accessing the graph world interface. The user can provide one or more inputs, which can be obtained by the graph world system. The generator configurator and the model configurator 402 can then be utilized to generate and/or obtain a plurality of synthetic graph datasets and a plurality of graph models. Based on the one or more inputs, a job manager of a dataflow block 404 can deploy and schedule the generation or retrieval of the plurality of synthetic graph datasets generated or stored using the cloud platform 406. The progress and relevant logs may be sent back to the dataflow blog for record keeping.

The plurality of graph models can then be obtained and trained using the plurality of synthetic graph datasets. The trained models can then be evaluated to generate evaluation data. The evaluation data can then be stored using a cloud storage platform 408. In some implementations, the evaluation data can be stored with a description of the experiment type (e.g., node classification experiment, graph classification experiment, link prediction experiment, etc.). Additionally and/or alternatively, the evaluation data may be readily viewable and/or readily searchable. In some implementations, the evaluation data can be provided for display as a tabular result 410.

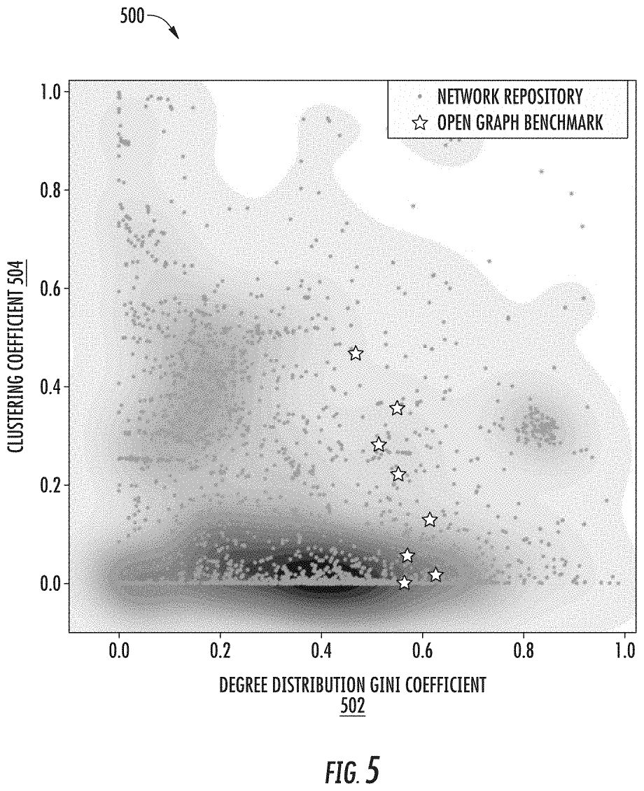

FIG. 5 depicts an illustration of an example distribution of graphs according to example embodiments of the present disclosure. The distribution of graphs from an open graph benchmark may not match the distribution of graphs available on the web. The systems and methods disclosed herein can allow statistically sound insights about GNN model performance through the use of extensive sampling over the set of all possible graphs.

In particular, FIG. 5 depicts an example distributions graph 500 that can be descriptive of existing graph datasets. The example distributions graph 500 can convey the distribution of the network repository of graphs with relation to a degree distribution gini coefficient 502 and a clustering coefficient 504. As illustrated by the example distributions graph 500, the open graph benchmark and other training datasets can fail to be representative of a full range of possible graphs. Therefore, the systems and methods disclosed herein can leverage the generation and use of synthetic graph data to provide more representative training datasets for training and evaluating machine-learned graph models.

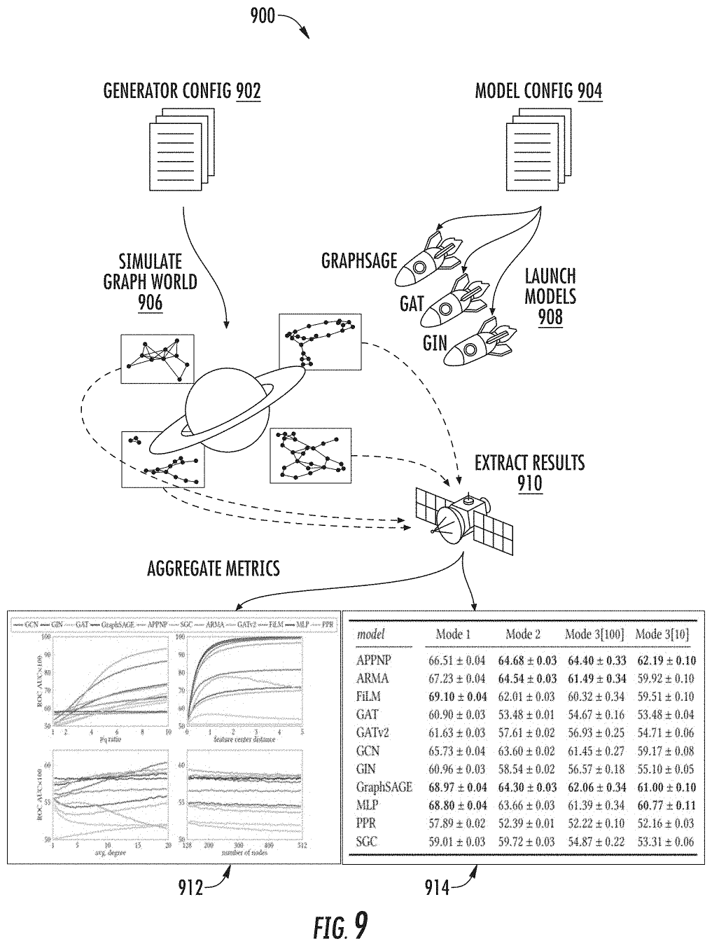

FIG. 9 depicts a block diagram of an example graph model training and testing according to example embodiments of the present disclosure. In particular, FIG. 9 depicts an illustration of GraphWorld. The user can specify a config defining a synthetic graph generator and a list of GNN models. In some implementations, GraphWorld can produce a diverse “world” of synthetic graphs and can benchmark each GNN at all locations in the world. The system controller can extract all benchmark results, aggregates, and can produce output that compares models.

The graph model training and testing system 900 in FIG. 9 can begin with a generator configurator 902 facilitating the generation of a plurality of graph datasets using one or more generators that sample a domain of possible graphs and/or features. The model configurator 904 can facilitate the launching of a plurality of graph models 908 (e.g., launching a GraphSAGE model, a GAT model, and a GIN model). The graph world can then be simulated 906 to generate a plurality of trained graph models using the plurality of graph datasets and the plurality of graph models.

The plurality of trained graph models can then be tested using one or more input graph datasets in order to extract evaluation results 910. The extracted results can then be utilized to evaluate the performance of the plurality of trained graph models using one or more metrics. The evaluated metrics can then be aggregated to generate graph representations 912 and tabular representations 914. The user can then reference at least one of the graph representation or the tabular representation in order to choose a particular graph model architecture and hyperparameters for a task.

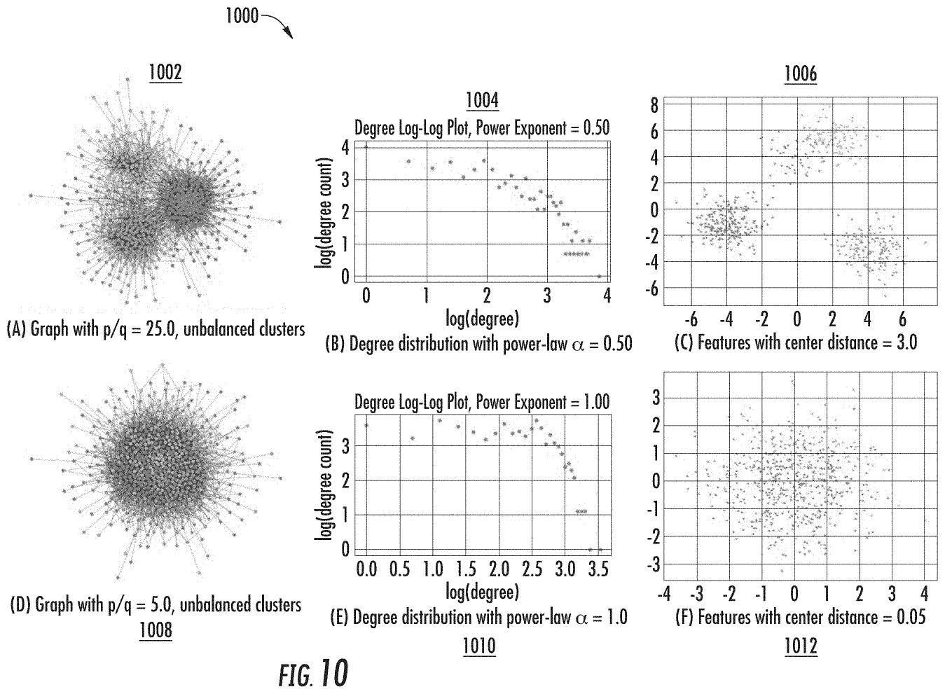

FIG. 10 depicts an illustration of example node classification datasets 1000 according to example embodiments of the present disclosure. In particular, FIG. 10 can depict node classification datasets generated by GraphWorld.

FIG. 10 can include visualizations of two separate attributed DC-SBM realizations from a graph world. In some implementations, each of the parameters depicted may be randomly sampled from a wide range, which can produce a diverse classification of node classification datasets. Specifically, FIG. 10 depicts different parameter distributions for example node classification datasets 1000. FIG. 10 includes a graph representation of p/q=25.0, unbalanced clusters 1002; a graph representation of a degree distribution with power-law α=0.50 1004; a graph representation of features with a center distance=3.0 1006; a graph representation of p/q=5.0, unbalanced clusters 1008; a graph representation of a degree distribution with power-law α=1.0 1010; and a graph representation of features with a center distance=0.05 1012.

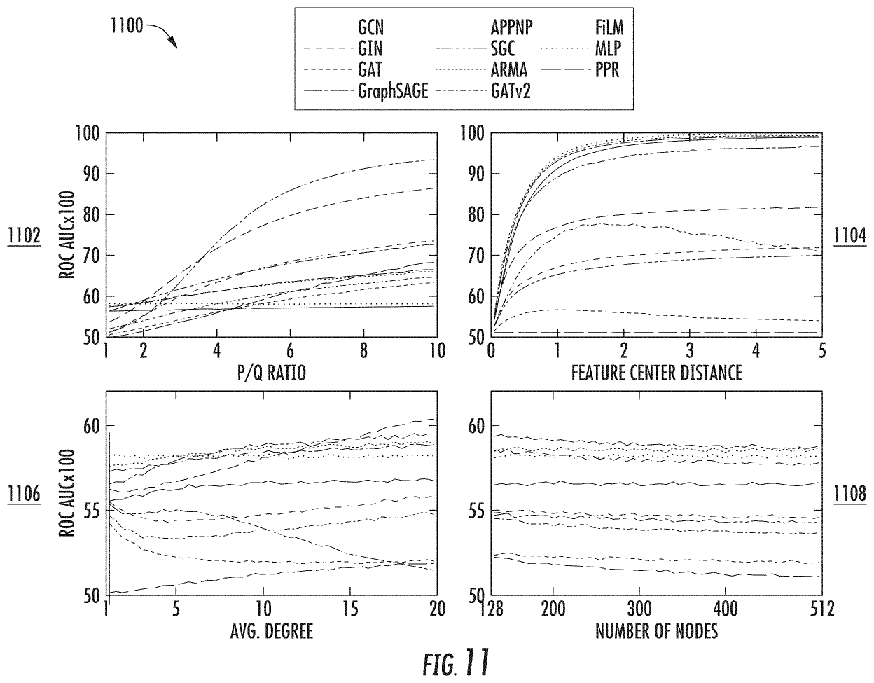

FIG. 11 depicts an illustration of example node classification results 1100 according to example embodiments of the present disclosure. In particular, FIG. 11 can depict node classification results from a fixed default parameter set.

In some implementations, one or more of the depicted result graphs may be provided as part of the evaluation representation. Each of the depicted graphs can convey the ROC AUC×100 against the respective independent variables. The different independent variables depicted include the p/q ratio 1102, the feature center distance 1104, the average degree 1106, and the number of nodes 1108. A user may utilize these result graphs to determine a particular graph architecture and particular parameters for a node classification task.

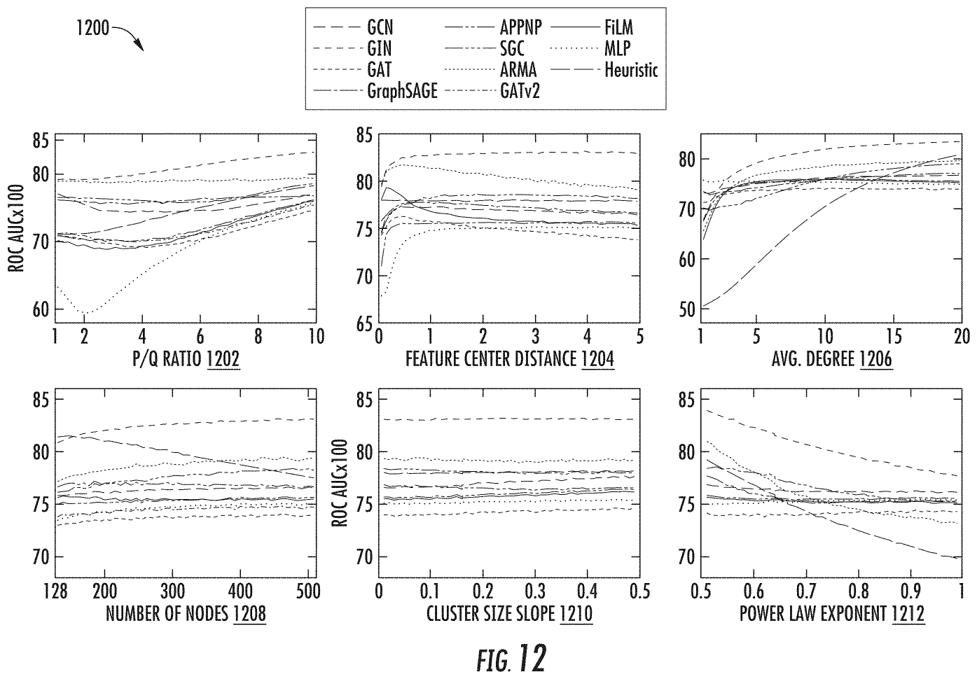

FIG. 12 depicts an illustration of example link prediction results 1200 according to example embodiments of the present disclosure. In particular, FIG. 12 can depict link prediction results from a fixed default parameter set.

In some implementations, one or more of the depicted result graphs may be provided as part of the evaluation representation. Each of the depicted graphs can convey the ROC AUC×100 against the respective independent variables. The different independent variables depicted include the p/q ratio 1202, the feature center distance 1204, the average degree 1206, the number of nodes 1208, the cluster size slope 1210, and the power law exponent 1212. A user may utilize these result graphs to determine a particular graph architecture and particular parameters for a link prediction task.

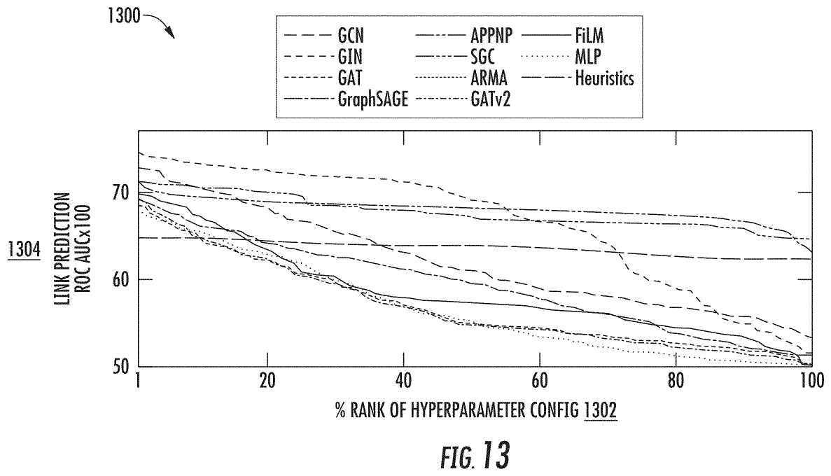

FIG. 13 depicts an illustration of example hyperparameter tuning results 1300 according to example embodiments of the present disclosure. In particular, FIG. 13 can depict hyperparameter tuning performance dropoff.

FIG. 13 can display an example dropoff in performance of unique sampled hyperparameter configurations for a graph world link prediction mode 1 experiment 1304. Each configuration can have an average test metric score, averaged over each graph world location at which the hyperparameter may be sampled. The lines in this plot can represent the ordered scores for each model, and the x-axis 1302 can represent the inverse percentile rank of the score. The depiction can illustrate that for most models, there may be no “elbow” or clear break between a top-performing hyperparameter configuration and the next 10-20 top performing configurations.

### Example Methods

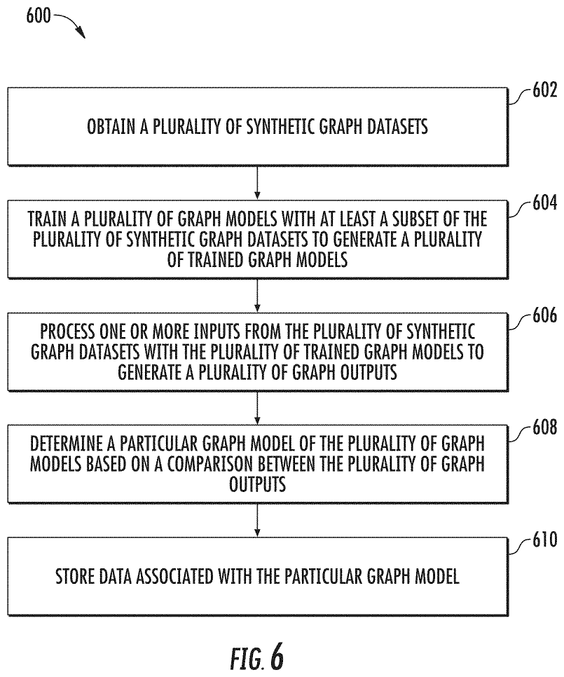

FIG. 6 depicts a flow chart diagram of an example method to perform according to example embodiments of the present disclosure. Although FIG. 6 depicts steps performed in a particular order for purposes of illustration and discussion, the methods of the present disclosure are not limited to the particularly illustrated order or arrangement. The various steps of the method 600 can be omitted, rearranged, combined, and/or adapted in various ways without deviating from the scope of the present disclosure.

At 602, a computing system can generate a plurality of synthetic graph datasets. The plurality of synthetic graph datasets can include structured-graph data (e.g., knowledge graphs, world wide web data, and/or social network data). In some implementations, each of the plurality of synthetic graph datasets can include a realization of a parameterized probability distribution. Additionally and/or alternatively, each of the plurality of synthetic graph datasets may include one or more training graphs, one or more training features, and/or one or more training labels.

In some implementations, the one or more generators can include one or more attributed-graph generators. Additionally and/or alternatively, the one or more generators can include one or more label generators. Moreover, in some implementations, the plurality of synthetic graph datasets can be generated based on the input data. The plurality of synthetic graph datasets can include a plurality of labels associated with the specific task.

At 604, the computing system can train a plurality of graph models with at least a subset of the plurality of synthetic graph datasets to generate a plurality of trained graph models. In some implementations, each of the plurality of graph models can include a graph neural network.

At 606, the computing system can process one or more inputs from the plurality of synthetic graph datasets with the plurality of trained graph models to generate a plurality of graph outputs. In some implementations, the subset of the plurality of synthetic graph datasets and the one or more inputs from the plurality of synthetic graph datasets may differ. The one or more inputs can be selected by randomly searching the plurality of synthetic graph datasets to determine representative inputs for testing the models. In some implementations, one or more vectors of metrics can be computed for each graph output. The vector graph statistics and highest scoring hyperparameters can then be utilized to generate an architecture prediction function.

At 608, the computing system can determine a particular graph model of the plurality of graph models based on a comparison between the plurality of graph outputs. In some implementations, the particular graph model can be determined based on a comparison between the output of the particular graph model and a ground truth output. The respective output of the particular graph model may be the output of the plurality of outputs that has the highest similarity score to the ground truth output.

At 610, the computing system can store data associated with the particular graph model. The particular graph model can be stored with the data associated with a particular training dataset, evaluation data, and/or the generated output(s). In some implementations, the data can be stored in a searchable database to enable graph model architecture and hyperparameter search.

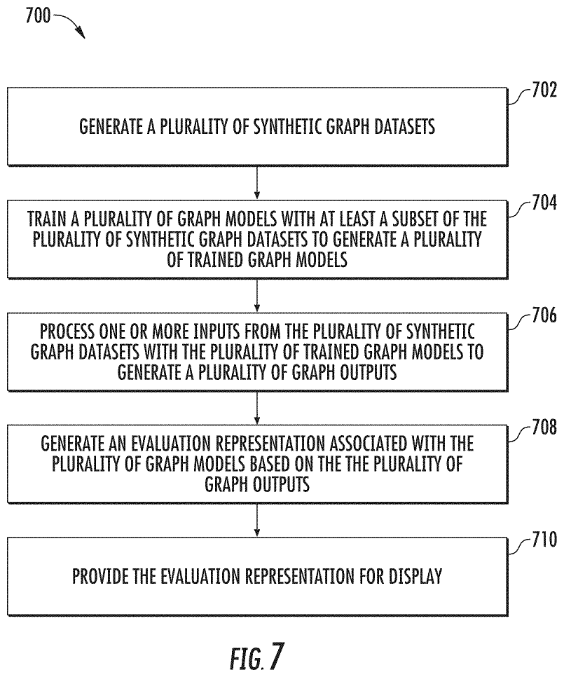

FIG. 7 depicts a flow chart diagram of an example method to perform according to example embodiments of the present disclosure. Although FIG. 7 depicts steps performed in a particular order for purposes of illustration and discussion, the methods of the present disclosure are not limited to the particularly illustrated order or arrangement. The various steps of the method 700 can be omitted, rearranged, combined, and/or adapted in various ways without deviating from the scope of the present disclosure.

At 702, a computing system can generate a plurality of synthetic graph datasets. The synthetic graph datasets can include structured-graph data. In some implementations, the synthetic graph datasets can include one or more graphs, one or more features, and/or one or more labels. Additionally and/or alternatively, the synthetic graph datasets can be generated with one or more generators conditioned by instructions provided by a manager generator that instructs the one or more generators to sample from a given region of a space of possible datasets.

At 704, the computing system can train a plurality of graph models with at least a subset of the plurality of synthetic graph datasets to generate a plurality of trained graph models. In some implementations, the graph models may be diverse in architecture. Additionally and/or alternatively, the plurality of models can include subsets of graph models with the same or similar architecture that are then trained on differing training datasets.

At 706, the computing system can process one or more inputs from the plurality of synthetic graph datasets with the plurality of trained graph models to generate a plurality of graph outputs. In some implementations, the plurality of graph outputs may be compared against ground truth outputs in order to determine a deviation from the ground truth.

At 708, the computing system can generate an evaluation representation associated with the plurality of graph models based on the plurality of graph outputs. The evaluation representation can be descriptive of the performance of different graph models as determined based on the graph outputs. For example, the evaluation representation may depict a graphical representation of statistical data metrics determined based on the outputs. The graphical representations may include a scatter plot, a table, a line graph, a set of line graphs, etc. In some implementations, the evaluation representation can be descriptive of each model's performance on one or more tasks (e.g., graph classification, node classification, link prediction, etc.).

At 710, the computing system can provide the evaluation representation for display. The evaluation representation can be displayed via a graphical user interface. In some implementations, the graphical user interface may be provided as part of a web application, a localized application, or via a web service.

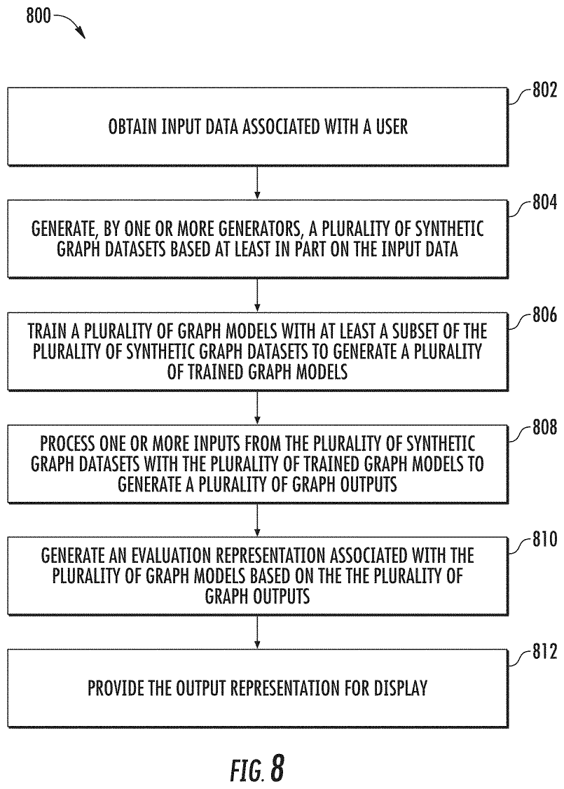

FIG. 8 depicts a flow chart diagram of an example method to perform according to example embodiments of the present disclosure. Although FIG. 8 depicts steps performed in a particular order for purposes of illustration and discussion, the methods of the present disclosure are not limited to the particularly illustrated order or arrangement. The various steps of the method 800 can be omitted, rearranged, combined, and/or adapted in various ways without deviating from the scope of the present disclosure.

At 802, a computing system can obtain input data associated with a user. The input data can include one or more inputs received from a user computing device. The one or more inputs can indicate a specific task and/or may indicate a set of data of interest. Alternatively and/or additionally, the input data may be descriptive of a graph model architecture the user desires to be evaluated.

At 804, the computing system can generate, by one or more generators, a plurality of synthetic graph datasets based at least in part on the input data. In some implementations, the synthetic graph datasets can be generated based on a conditioning input that indicates dataset conditions for which graphs and features may be selected for use in graph dataset generation.

At 806, the computing system can train a plurality of graph models with at least a subset of the plurality of synthetic graph datasets to generate a plurality of trained graph models. The plurality of trained graph models can include a plurality of different graph model architectures and a plurality of different graph model hyperparameters.

At 808, the computing system can process one or more inputs from the plurality of synthetic graph datasets with the plurality of trained graph models to generate a plurality of graph outputs. Each of the graph outputs can be descriptive of a node classification, a graph classification, and/or a link prediction.

At 810, the computing system can generate an output representation associated with the plurality of graph models based on the plurality of graph outputs. The output representation can be descriptive of the performance of different architectures and hyperparameters. Alternatively and/or additionally, the output representation may include one or more predictions, or suggestions, of different architectures and/or hyperparameters to utilize for specific tasks or datasets.

At 812, the computing system can provide the output representation for display. The output representation can be provided for display via a graphical representation of the output representation in a user interface of a graph world application, in a user interface of a web service, or in an automated communication.

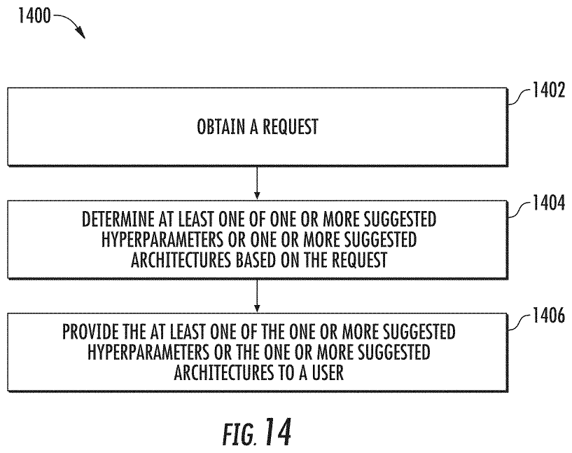

FIG. 14 depicts a flow chart diagram of an example method to perform according to example embodiments of the present disclosure. Although FIG. 14 depicts steps performed in a particular order for purposes of illustration and discussion, the methods of the present disclosure are not limited to the particularly illustrated order or arrangement. The various steps of the method 1400 can be omitted, rearranged, combined, and/or adapted in various ways without deviating from the scope of the present disclosure.

At 1402, a computing system can obtain a request. The request can be a search request to search a database of possible hyperparameters and/or possible graph model architectures. The database can include evaluation data descriptive of the performance of trained graph models with specific hyperparameters and/or specific model architectures. In some implementations, the request can be descriptive of an unseen dataset (e.g., a dataset that was not in any of the training datasets utilized during graph model training and testing) and/or a specific task for performance. Additionally and/or alternatively, the possible hyperparameters and/or the possible model architectures may be stored in the database with one or more indicators indicating the specific strengths and/or weaknesses of the specific hyperparameters and model architectures. In some implementations, the systems and methods can include mapping between the characteristics of the graph input data, the model architecture, and the hyperparameter choices to each model's performance. Additionally and/or alternatively, The systems and methods may learn a regression over this input description vector and descriptions of the best fit models (i.e., hyperparameters) in order to predict which hyperparameters and architectures to use on new datasets.

At 1404, the computing system can determine at least one of one or more suggested hyperparameters or one or more suggested architectures based on the request. The one or more suggested hyperparameters and/or the one or more suggested model architectures can be determined based on the learned regression over the input description vector and descriptions of the best fit models. Alternatively and/or additionally, the suggested hyperparameters and/or the suggested model architectures can be determined based on a stored index of which hyperparameters and model architectures perform well on a task or dataset indicated by the request.

At 1406, the computing system can provide the at least one of the one or more suggested hyperparameters or the one or more suggested architectures to a user. In some implementations, the computing system can provide suggested configurations via a graph world user interface. Additionally and/or alternatively, the computing system can provide a graph model with the suggested hyperparameters and architecture for use.

### Example Implementations

The systems and methods disclosed herein can include a novel framework and software package (GraphWorld) for testing GNN models on an arbitrarily-large population of synthetic graphs. GraphWorld can allow a user to efficiently generate a world with millions of statistically diverse graphs and can be designed to be accessible, scalable and easy to use. In some implementations, GraphWorld can be run on a single machine without specialized hardware or can be easily scaled up to run on arbitrary clusters or cloud frameworks. Using GraphWorld, a user can have fine-grained control over graph generator parameters and can benchmark arbitrary GNN models with built-in hyperparameter tuning.

The systems and methods disclosed herein can be utilized to provide insights regarding the performance characteristics of tens of thousands of GNN models. Comparisons can be made between models for which was infeasible to make in any previous work. The systems and methods can efficiently explore the graph worlds and characterize (at scale) the relationship between graph generator parameters and task performance metrics.

Graph Neural Networks (GNNs) can extend the benefits of deep learning to the non-Euclidean domain, allowing for standardized and re-usable machine learning approaches to problems that involve relational (graph-structured) data. GNNs can admit an extremely wide range of architectures and possible tasks, including node classification, whole-graph classification, and link prediction. With the growth of graph models, increased calls for proper GNN experimental design, refreshed benchmark datasets, and fair comparisons of GNN models in reproducible settings may be of increased utility.

In some implementations, the systems and methods can include a GraphWorld system. GraphWorld can include a scalable, reproducible, and computationally-lean system for benchmarking GNN models on synthetic graph data. With GraphWorld's ability to generate a vast and diverse “world” of graph datasets for a particular task, as illustrated in FIG. 9, GraphWorld can allow comparisons between GNN models and architectures that are not possible with the handful of standard graph datasets on which the current literature depends. Each of the currently standard datasets may be a poor representation of the space of possible graphs, as illustrated in FIG. 5. GraphWorld can compute model performance over a vast region of this space, revealing aggregate differences between GNN designs that cannot otherwise be observed. Therefore, the systems and methods can utilize GraphWorld as a methodology that can complement existing and future studies on natural graph datasets. In some implementations, the systems and methods can include the following contributions: problem formulation, methodology, and insight.

The formulated problem can include measuring GNN model performance across graph datasets with extremely large statistical variance. Modern benchmark datasets, however well-maintained, may be limited in scope and can be computationally inaccessible to the average researcher.

The methodology can include GraphWorld, a graph sampling and GNN training procedure which can be capable of testing state-of-the-art GNNs on task datasets beyond the scope of any existing benchmarks.

GraphWorld can be utilized to conduct large-scale experimental study on over 1 million graph datasets for each of three GNN tasks—node classification, link prediction, and graph classification. The systems and methods can provide a novel method to explore the GNN model performance across all locations in the graph worlds that are generated.

Inadequate generalization, incremental overfitting, and un-scalable development can be inherent to the need of GNN researchers to benchmark on datasets sourced from the real world. Studies on very large graphs can be necessary to demonstrate the scalability of proposed GNN architectures. Such large graphs can be expensive to collect and process and can rely on specialized hardware or computing clusters to train the models, limiting access to research for under-represented groups.

In some implementations, the systems and methods can include the GraphWorld system and framework. Graphworld can include a distributed framework for simulating diverse populations of GNN benchmark datasets, tuning and testing an arbitrary number of GNN models on the population, and extracting population-level insights from the logs of the system. GraphWorld can provide generalizable GNN insights in a scalable manner that is accessible to researchers with low computational resources.

The core component of GraphWorld can be the simulation of GNN test datasets using attributed-graph and label generators. Each test dataset can be a realization of a parameterized probability distribution [symbol] (π₁, π₂, . . . ) on [symbol] = [symbol] × [symbol] × [symbol] , where [symbol] is a collection of graphs, [symbol] is a collection of features, and [symbol] is a collection of labels. (This formulation can support graph classification datasets, which can be represented as a single graph of disjoint graph examples). The space of possible test datasets [symbol] can be fully determined by regions of generator parameters π₁∈Π₁, π₂∈Π₂, . . . provided by the user to the workers via the manager. Each worker in a GraphWorld pipeline can generate a single realization D∈ [symbol] by sampling a generator parameter set (π₁, π₂, . . . ), and then sampling a single dataset from [symbol] (π₁, π₂, . . . ). In some implementations, each dataset sampled can be a combination D=[Dₜᵣₐᵢₙ, Dₜₑₛₜ] of training data and testing data for the GNN models.

For example, the simulation component of GraphWorld can be illustrated with a node classification task generation. In some implementations, the systems and methods can generate worlds of node classification tasks from samples G×L∈ [symbol] × [symbol] as a Degree-Corrected Stochastic Block Model (DC-SBM) graphs, where cluster assignments double as class labels, and node features F∈ [symbol] are drawn from within-cluster multivariate Normals. Each of these distributions can have many dependent parameters, such as the p-to-q ratio (where p and q are the probabilities of in-cluster, outcluster edges), the degree power-law α, the variance of multivariate Normal centers, the cluster size distribution. FIG. 10 can illustrate visualizations of two separate attributed DC-SBM realizations from a graph world. In a full run of GraphWorld, each of these parameters (and more) can be randomly sampled from a wide range, producing a diverse classification of node classification datasets.

The GraphWorld method can simulate a pre-specified number of GNN test datasets D1, D2, . . . ∈ [symbol] , in the manner described above, and can train and test an arbitrary list of GNN models on each dataset. The particular task can be fully-generalizable beyond node classification. Additionally and/or alternatively, the systems and methods can demonstrate link prediction and graph property prediction. Similarly to the test data distributions, the hyperparameters of GNN model m (for a particular dataset) can be determined by a sample or specification (hₘ₁, hₘ₂, . . . )∈ [symbol] =Hₘ₁×Hₘ₁×Hₘ₂× . . . . The complete set of inputs to the GraphWorld method can include:

Models: list of models m₁, m₂, . . . and associated hyperparameter spaces [symbol] , . . . ;
Task formulation: space of possible datasets [symbol] , and a probability distribution [symbol] (π₁, π₂, . . . ) defined on [symbol] ;
Task metric: test accuracy function EvalMetric(m, D); and
Size N: number of datasets to sample on the graph world.

With these inputs, the GraphWorld system can be parallel over N location on the graph world.

The systems and methods can have the ability to analyze the response of GNN models to the task generator parameters described previously. However, not all configurations (π₁, π₂, . . . ) in parameter space may provide equivalent insights. As one example, extremely small values of πᵢ=number of vertices (such as 2 or 3) may not be useful to exploring other parameters, like edge density, or the skewness of the degree distribution, since GNN models can either perform poorly or perfectly on trivially-sized graphs regardless of other parameters.

The systems and methods may provide a methodology to mine a large (random) sample of GraphWorld generator configurations for the most “effective” configuration, which can mean that deviations from that configuration affect GNN model performance most strongly. The systems and methods can generate a graph world for a given task T with generator parameter space Π, and at each location k at the graph world the system can have a sampled configuration \hat{Π}ₖ∈Π and an average GNN test metric zₖ. Conceptually, a sampled configuration \hat{Π}=(π₁, π₂, . . . ) can be most effective if for every πᵢ=\hat{Π}, changing the value of any other parameter πⱼ produces variance in the test metrics of GNN models. To find such a configuration, the systems and methods can perform marginal optimization on the space of parameters Π. Using the samples {(\hat{Π}ₖ, zₖ)} on an initial run of a GraphWorld pipeline, the systems and methods can find a (locally) optimal setting for each ηᵢ in the following manner. The system may first bin each dimension of Π into a fixed number of quantile bins. Then for each quantized value ηᵢ=x, the system can compute the average F statistic between the other parameter values ηⱼ and the test metric z (on graph world locations where ηᵢ=x). The system can =then set ηᵢ to the x value that produced the highest F statistic. The configuration can provide an optimal generator configuration from which we can efficiently sample a smaller but still-interesting graph world.

In some implementations, the systems and methods can include auto-machine-learning hyper-parameter prediction. The auto-machine-learning hyper-parameter prediction can be performed by utilizing one or more machine-learned models.

For example, the systems and methods can first generate a GraphWorld dataset. A GraphWorld dataset can include a table of graph benchmark dataset results. In some implementations, each table row can include the following fields: (P) input parameters to the synthetic graph model; (S) graph statistics computed on the graph output of the synthetic graph model; and (H) hyperparameters used for the GNN model being tested on the graph.

Next, the systems and methods can train a model to predict H given an input graph. In particular, the systems and methods can let E={(G_i, P_i, S_i, H_i)} be the set of GraphWorld dataset examples. In some implementations, the system can use E to train a function ƒ(G, S)=H from graph/statistic space to hyperparameter space. Given a new graph G*, the system can predict optimal GNN hyperparameters H*=ƒ(G*, S*).

With the GraphWorld dataset, the system can train a retrieval model ƒ(G)→H, where G can be an input graph and H, can be a hyperparameter vector

The generator parameter names can be varied for each respective SBM (p/q, feature center distance). For example, the generator parameters can include: (nvertex) number of vertices in the graph; (avg_degree) average degree of the graph; (feature_center_distance) variance of the multivariate means of the node feature clusters; (feature_dim) dimension of the node feature clusters; (edge_feature_dim) dimension of the edge feature clusters; (edge_center_distance) variance of the multivariate means of the edge feature clusters; (p_to_q_ratio) ratio between the within-cluster edge probability and the between-cluster edge probability; (num_clusters) number of clusters in the graph; (cluster_size_slope) slope of the ordered cluster size proportions; and (power_exponent) exponent of the power law that generates expected node degrees.

In some implementations, the systems and methods can utilize one or more GraphWorld hyperparameter tuning workflows. The workflows can be designed to facilitate more fine-grained comparisons between models, using GraphWorld. The workflows may not have any relationship to AutoML hyper-parameter predictions.

For workflow/mode 1 (unoptimized), each model can be trained and tested using a random hyperparameter configuration from the hyperparameter distribution.

For workflow/mode 2 (global optima), given a GraphWorld dataset run with workflow/mode 1, the system can compute the globally optimal hyperparameter configuration for each model. The system can then use that configuration for every GraphWorld graph.

For workflow/mode 3 (local optima), each model can be trained using a validation set to optimize its hyperparameter configuration on that graph.

In some implementations, the systems and methods can utilize an interestingness metric.

The system can use the interestingness metric to select the default state (e.g., a set of generator parameters which can produce the most variation when varying each individual parameter). The default state can be a point where most of the parameters can greatly influence the model performance (e.g., a bifurcation point).

Additionally and/or alternatively, the interestingness metric can be used to rank the parameters in the order of their potential interest to be examined by the researcher. Since the number of the graph statistics, generator parameters, and model parameters can be high, the order of interest can be hard for a human to interpret tens of charts with millions of points in each one. The interestingness metric can allow the user to quantify the importance of varying each individual parameter or statistic, leading to better understanding of important factors in model design and dataset performance.

### Example Experiments

The example experimental design for the GraphWorld method can show how to efficiently sample a useful part of any graph world. The systems and methods can be utilized for evaluation of node classification, graph classification, and link prediction, and how the tasks may be generated in various graph worlds. The systems and methods can list the GNN models tested with the GraphWorld applications and can present novel GraphWorld modes of hyperparameter tuning and inference.

For an example experiment, the system can choose 9 representative GNNs and 3 baselines to illustrate the strengths of our proposed approach. The nine representative GNNs can include: ARMA (i.e., a GNN with auto-regressive moving average filters), APPNP (i.e., one of the first ‘linear’ GNNs, accelerating propagation using Personalized PageRank), FiLM (i.e., a model that can modulate an incoming message by the features of the target node), GAT (i.e., an early model of graph attention), GATv2 (i.e., an improved variant of graph attention that can allow any node to attend to any other one), GCN (i.e., a seminal model that can average neighbor state at each iteration), GIN (i.e., the model can use MLPs to transform summations of neighbor features), GraphSAGE (i.e., a variant of the GCN which can add uses sampling and improved propagation of the hidden state), and SGC (i.e., another approach to linear GNNs using matrix multiplication).

In addition, the experimentation can examine several baselines which may not be GNNs. The baselines can include: linear regression (for graph property prediction), multi-layer perceptron (for features), personalized PageRank (for graph), and link prediction heuristics (for graph).

The linear regression baseline can include simple and ordinary least-squares with edge density as the sole feature. The multi-layer perceptron baseline can include transforming the node features via a DNN for classification. The personalized PageRank baseline can include predicting node labels for unseen nodes via Personalized PageRank seeded by the labeled nodes. For each unseen node, the system can compute the total probability mass that comes from the vertices of each label and can pick the label with the highest score. Additionally and/or alternatively, the link prediction heuristics baseline can create a link prediction ranking using eight different reweighting schemes for counting common neighbors. The system can pick one of the following schemes: (i) Sorensen-Dice coefficient, (ii) cosine similarity, (iii, iv) hub-promoted and hub-suppressed similarity, (v) Jaccard similarity, (vi) Adamic-Adar index, (vii) Resource Allocation index, and (viii) Leicht-Holme-Newman similarity.

The GNN models can use the reference implementations from the PyTorch-Geometric library.

GNN hyperparameter tuning can be essential for understanding model performance and can be an aspect of GNN experimentation that can be efficiently explored with GraphWorld. A GraphWorld pipeline can be run in one of three hyperparameter modes.

Mode 1 can include each model m being trained and tested with a random draw (hₘ₁, hₘ₂, . . . )∈ [symbol] ₘ, its hyperparameter configuration space.

Mode 2 can include assuming a GraphWorld pipeline that may have been already run in Mode 1. For any model m, let Ĥᵢ be the i-th unique configuration sampled (at any location in the graph world). Let be the collection of GraphWorld datasets for which Ĥᵢ may be sampled for m. Mode 2 can include running another GraphWorld pipeline with the best config H*ₘ defined as:

$${H}^{*} = {argmax}_{{\hat{H}}_{i}} {\vert {𝒟}_{i} \vert}^{- 1} {\sum }_{D ∈ {𝒟}_{i}} EvalMetric ( m ( {\hat{H}}_{i} ) , D ) . \qquad ( 1 )$$

The system may pick the hyperparameters that achieve the best average performance across all GraphWorld samples.

Mode 3 can include each model m receiving a budget oft tuning rounds, and the hyperparameter configuration, which can perform best on a held-out validation set, may be used to compute the test metric.

For the node classification (NC) task experiment, the system can generate graphs using the Stochastic Block Model (SBM). First, node labels (classification targets) can be generated from a multinomial distribution, which can define the node clusters. Edges can be generated as Bernoulli random variables following within-block probability p and between-block probability q (p≥q). Node features may be generated from a within-cluster multivariate Normal distribution, with unit (diagonal) covariance, and cluster centers can be drawn from a prior multivariate Normal. The variance of the prior can control the degree of separation between the cluster feature centers. The number of clusters, the cluster size, and the power law of the expected degree distribution can be varied. In some implementations, the system can tune and test GNN models with ROC-AUC one-vs-rest (AUC-ovr). The system may train models on a random sample of 5 nodes per-class, may tune on a (disjoint) random sample of 5 nodes per-class, and may test on the rest of the nodes.

For the link prediction (LP) task experiment, the system can generate graphs using the SBM, as for node classification. However, to simulate a link prediction setting, the system may randomly split edges into training, validation, and test sets. The task can be to predict the “unseen” edges in the test set, which the system can evaluate with the ROC-AUC metric against randomly chosen negatives. In some implementations, the system can train on 80% of the edges, can tune on 10% of the edges, and may test on the remaining 10%.

For the graph property prediction (GPP) task experiment, the system can generate a dataset of small Erdös-Renyi random graphs. The task can be to infer the number of a certain motif in each test graph. In this paper, we evaluate tailed-triangle motif counting. In some implementations, the system may evaluate the models with scaled mean-squared-error (S-MSE): Σ(yᵢ−yₗ)²/Σ(yᵢ−y̅)², which can be comparable across datasets with different scales of motif counts. The system can give a dummy unit one-dimensional feature to each node. Here, the number of training graphs may be a variable parameter. The system may tune on 20% of the data and may test on the remainder.

For experimentation purposes, the system may be performed with twelve GraphWorld pipelines, one for each of three tasks, and with all three hyperparameter optimization modes per task, running Mode 3 twice with 10 and 100 tuning rounds. To sample more efficiently from useful regions of the graph worlds, the system can be applied with the GraphWorld exploration technique to the Mode 1 experiments, extracting default configurations to use for Mode 2 and Mode 3. In those modes, the system may sample only one parameter from the generator, holding the other parameters fixed at the default configuration.

The system can analyze the results using average test accuracy of each model, both globally over the entire graph world, and marginally, within buckets of key generator parameters. Marginal parameter analysis can be a unique and powerful property of GraphWorld, allowing us to examine the average response of GNN models to particular, explainable characteristics of the task. The tables can present experimental global averages, and marginal averages in line plots can show the sensitivity of models to the generator parameters. For example purposes, all tables and plots may use data from GraphWorld Mode 3 experiments.

As shown in Tables 1, 2, and 3, most models tested in GraphWorld Mode 2 uniformly outperform their counterparts tested in Mode 3. The results can mean that, for most models, using per-dataset hyperparameter tuning may not outperform simply using the average best-performing hyperparameter configuration from the large GraphWorld Mode 1 application. The result can be somewhat counter-intuitive, as one might expect that local tuning would help correct for variance in the graph world that the best global-average hyperparameter configuration could not. Furthermore, as seen in FIG. 13 many of the top-performing hyperparameter configurations from GraphWorld Mode 1 may have similar average test accuracy (there may be no stand-out best configuration). While the system can be cautious about how this observation applies to graphs with more complex features, the system may not reduce the amount of computation necessary to find good hyper-parameters for models in GraphWorld. As a result of the finding the figures and tables may contain data from just GraphWorld Mode 2 experiments.

| model | Mode 1 | Mode 2 | Mode 3 [100] | Mode 3 [10] |
|---|---|---|---|---|
| APPNP | 1.04 ± 0.00 | 1.02 ± 0.00 | 1.05 ± 0.00 | 1.04 ± 0.00 |
| ARMA | 1.03 ± 0.00 | 1.00 ± 0.00 | 0.99 ± 0.01 | 1.01 ± 0.00 |
| FiLM | 1.05 ± 0.00 | 1.02 ± 0.00 | 1.07 ± 0.01 | 1.05 ± 0.00 |
| GAT | 1.04 ± 0.00 | 1.02 ± 0.00 | 1.05 ± 0.00 | 1.04 ± 0.00 |
| GATv2 | 1.04 ± 0.00 | 1.02 ± 0.00 | 1.05 ± 0.00 | 1.05 ± 0.00 |
| GCN | 1.04 ± 0.00 | 1.02 ± 0.00 | 1.05 ± 0.00 | 1.04 ± 0.00 |
| GIN | 0.71 ± 0.00 | 0.41 ± 0.00 | 0.33 ± 0.03 | 0.35 ± 0.01 |
| GraphSAGE | 1.04 ± 0.00 | 1.02 ± 0.00 | 1.03 ± 0.00 | 1.03 ± 0.00 |
| LR | 0.52 ± 0.00 | 0.51 ± 0.00 | 0.54 ± 0.04 | 0.52 ± 0.01 |
| MLP | 1.04 ± 0.00 | 1.02 ± 0.00 | 1.05 ± 0.00 | 1.05 ± 0.00 |
| SGC | 1.08 ± 0.00 | 1.02 ± 0.00 | 1.10 ± 0.01 | 1.08 ± 0.00 |

Table 1 can illustrate example graph property prediction performance averages in terms of scaled MSE. Lower can be better.

Table 1 can show that among GNNs the system can be tested on the Graph Property Prediction graph world, only GIN achieved better-than-mean-fitting MSE, along with simple linear regression with edge density as a feature, which outperformed all other GNNs.

With GraphWorld, the systems and methods can produce a more controlled and reproducible study into substructure counting, using appropriately-scaled MSE, showing that most GNNs fail on the task, but surprisingly GIN does not (even though none of the GNNs are given meaningful features).

| model | Mode 1 | Mode 2 | Mode 3 [100] | Mode 3 [10] |
|---|---|---|---|---|
| APPNP | 66.51 ± 0.04 | 64.68 ± 0.03 | 64.40 ± 0.33 | 62.19 ± 0.10 |
| ARMA | 67.23 ± 0.04 | 64.54 ± 0.03 | 61.49 ± 0.34 | 59.92 ± 0.10 |
| FiLM | 69.10 ± 0.04 | 62.01 ± 0.03 | 60.32 ± 0.34 | 59.51 ± 0.10 |
| GAT | 60.90 ± 0.03 | 53.48 ± 0.01 | 54.67 ± 0.16 | 53.48 ± 0.04 |
| GATv2 | 61.63 ± 0.03 | 57.61 ± 0.02 | 56.93 ± 0.25 | 54.71 ± 0.06 |
| GCN | 65.73 ± 0.04 | 63.60 ± 0.02 | 61.45 ± 0.27 | 59.17 ± 0.08 |
| GIN | 60.96 ± 0.03 | 58.54 ± 0.02 | 56.57 ± 0.18 | 55.10 ± 0.05 |
| GraphSAGE | 68.97 ± 0.04 | 64.30 ± 0.03 | 62.06 ± 0.34 | 61.00 ± 0.10 |
| MLP | 68.80 ± 0.04 | 63.66 ± 0.03 | 61.39 ± 0.34 | 60.77 ± 0.11 |
| PPR | 57.89 ± 0.02 | 52.39 ± 0.01 | 52.22 ± 0.10 | 52.16 ± 0.03 |
| SGC | 59.01 ± 0.03 | 59.72 ± 0.03 | 54.87 ± 0.22 | 53.31 ± 0.06 |

Table 2 can illustrate example node classification performance averages in terms of ROC-AUC Higher can be better.

| model | Mode 1 | Mode 2 | Mode 3 [100] | Mode 3 [10] |
|---|---|---|---|---|
| APPNP | 68.01 ± 0.01 | 76.26 ± 0.01 | 74.38 ± 0.09 | 74.07 ± 0.03 |
| ARMA | 63.31 ± 0.02 | 78.66 ± 0.01 | 78.85 ± 0.13 | 76.80 ± 0.05 |
| Heuristics | 63.77 ± 0.02 | 75.77 ± 0.01 | 75.60 ± 0.13 | 75.59 ± 0.04 |
| FiLM | 60.17 ± 0.02 | 74.99 ± 0.01 | 73.62 ± 0.11 | 71.69 ± 0.05 |
| GAT | 57.87 ± 0.02 | 73.67 ± 0.01 | 72.05 ± 0.12 | 68.50 ± 0.05 |
| GATv2 | 57.80 ± 0.02 | 74.48 ± 0.01 | 72.69 ± 0.12 | 69.16 ± 0.05 |
| GCN | 62.83 ± 0.02 | 76.42 ± 0.01 | 78.60 ± 0.10 | 75.70 ± 0.04 |
| GIN | 66.63 ± 0.02 | 81.95 ± 0.01 | 80.19 ± 0.11 | 78.57 ± 0.04 |
| GraphSAGE | 59.72 ± 0.02 | 75.02 ± 0.01 | 72.66 ± 0.11 | 71.33 ± 0.04 |
| MLP | 57.60 ± 0.02 | 73.91 ± 0.01 | 72.68 ± 0.11 | 71.32 ± 0.04 |
| SGC | 68.03 ± 0.02 | 77.13 ± 0.01 | 76.35 ± 0.09 | 75.19 ± 0.03 |

Table 3 can illustrate example link prediction mode averages in terms of ROCAUC. Higher can be better.

In some implementations, results from GraphWorld pipelines can show that no particular model may be dominant in the majority of trials, and furthermore many baselines perform comparably to recent state-of-the-art models. Tables 3 and 2 can show average test metrics over the Link Prediction and Node Classification graph worlds (respectively), with test metrics from the top-3 performing models shown in bold font under each GraphWorld mode. FIGS. 11 and 12 can show marginal averages for LP and NC (respectively) as the system can vary particular generator parameters. Additionally and/or alternatively, the system can point out a few observations from the results.

Table 3 can show the highest-ranked models among any GraphWorld modes may be ARMA (SotA), GIN/GCN (last 1-3 years), and APPNP/SGC (linear GNN baselines). Table 2 can show the highest-ranked models among any GraphWorld modes may be FiLM/ARMA (SotA), GraphSAGE (last 1-3 years), and APPNP/MLP (baselines). FIG. 4 can show that for NC, linear GNN baselines SGC and APPNP can easily compare to or outperform SotA and GCN methods when various features of the graph (such as the strength of the graph or feature clustering) may be modified.

FIG. 5 can show that for LP, while ARMA and GIN may outperform other methods on most ranges of dataset parameters, the LP heuristic and other baselines may perform comparably to SotA and recent GCN methods.

The observations may be counter-intuitive, since new models can typically claim a performance gain over all other existing work in order to get published. The results can imply that there may be a serious risk of overfitting to the small number of available benchmark datasets for GNNs.

The GraphWorld experiments on NC and LP tasks can offer both intuitive and counter-intuitive insights about GNN responsiveness to graph and node feature distributions.

In some implementations, the number of vertices may not matter. Across NC and LP tasks, the size of the graph (number of vertices) may have negligible effect on test AUC. The negligible effect can suggest that in many cases, the system may be sufficient to test new GNN architectures on small graphs produced by GraphWorld, rather than focusing on large graphs that may be currently being proposed as a one-size-fits-all solution to benchmarking GNNs.

For LP, differential sensitivity to degree distributions can be shown. For LP, four models (GIN, ARMA, SGC, and Heuristic) show increases in test AUC as the average degree increases. Those same models can be decreased in test AUC as the degree power-law becomes less heterogeneous. The results can suggest that these models can have some ability to capture node degree information and can reliably use that toward link prediction. For NC, differential sensitivity to graph and feature signal may be shown. For NC, most models may increase test AUC as the p-to-q ratio (graph cluster signal), and feature-center-distance (feature cluster signal) may be increased. Interestingly, attention-based methods (GAT, GATv2) may not respond as well to these parameters and may appear to respond negatively to stronger feature signals. FiLM and MLP, which can depend strongly on the features, may not respond at all to p/q, but may be among the top-performers as the feature signal increases.

Graph clusters, feature clusters, and cluster size may not affect LP. For link prediction, changing the cluster size may not seem to affect the performance of any model. Interestingly, the distance between feature clusters and p/q ratio may not have as strong of an effect on models as in the NC task, and some models may even appear to exhibit local-maxima behavior in response to these parameters. The results can suggest that these models (GAT, GATv2, ARMA, and FiLM) may not harness very powerful node features and may translate them to positional embedding for link prediction.

The systems and methods disclosed herein can address arbitrary generalization. With tunable parameters for GNN dataset generators, GraphWorld can simulate graphs with far-wider ranges of graph statistics than currently exist in any collection of benchmark datasets. The marginal analysis of parameters and statistics can generate insights about GNN architectures that may be unavailable from any small collection of re-used benchmark datasets.

Additionally and/or alternatively, the systems and methods can address re-usability without overfitting. Using the system disclosed herein, a GNN researcher can use GraphWorld to test their model as easily as any existing collection of GNN benchmarks, but without the danger of overfitting to graphs with particular properties.

| Hyperparameter | Values |
|---|---|
| Learning Rate | [0.01, 0.001, 0.0001] |
| Hidden Channels | [4, 8, 16] |
| Number of Layers | [1, 2, 3, 4] |
| Dropout | [0, 0.3, 0.5, 0.8] |
| α (APPNP, SGC, and PPR | [0.1, 0.2, 0.3] |
| baseline) | |
| Iterations (APPNP and SGC) | [5, 10, 15] |

Table 4 can illustrate example hyperparameter values for all models used by all GraphWorld experiments.

| Task | Mode | Samples (N) | Tuning Rounds | vCPU hours |
|---|---|---|---|---|
| LP | 1 | 1e6 | 0 | 1681 |
| LP | 2 | 7e5 | 0 | 1672 |
| LP | 3 | 7e4 | 10 | 2017 |
| LP | 3 | 7e3 | 100 | 1896 |
| NC | 1 | 1e6 | 0 | 1047 |
| NC | 2 | 7e5 | 0 | 755 |
| NC | 3 | 7e4 | 10 | 987 |
| NC | 3 | 7e3 | 100 | 937 |
| GPP | 1 | 1e6 | 0 | 9767 |
| GPP | 2 | 7e5 | 0 | 3399 |
| GPP | 3 | 7e4 | 10 | 4020 |
| GPP | 3 | 7e3 | 100 | 3553 |

Table 5 can illustrate resource complexity for Graph World experiments.

Moreover, the systems and methods disclosed herein can increase accessibility. As shown in Table 5, the system can run the GraphWorld method—100 k-1 m graphs, 9 models with hyperparameter tuning—in fewer CPU hours than it took to train and test one model on the largest OGB datasets. GraphWorld may not rely on expensive hardware nor dedicated specialized computing resources. In some implementations, the experiments can show that assessing GNN test performance may not depend on having natural, society-scale graph data. Combining the observations, the system may show that with GraphWorld, the system can derive new insights with less resources. The new insights can be particularly important to facilitate GNN research in smaller labs, making experiments more accessible.

Design goals for GraphWorld can be focused on accessibility, scalability, and efficiency. The system may be configured such that any researcher may be able to run GraphWorld simulations with minimal setup, while having the system automatically scale up experiments to available resources only as needed. To this end, GraphWorld may be implemented as a containerized Apache Beam1 pipeline allowing researchers to run a hermetic copy of Graph World on any infrastructure (i.e., a local machine, compute cluster, or cloud framework).

FIG. 4 can show the design of the GraphWorld distributed processing system. Table 5 can show the number of virtual-CPU hours needed to complete the twelve pipelines.

A list of hyperparameter values available to each GNN model (and some non-GNN models) for tuning can be listed in Table 4. In some implementations, the experiments can be focused on a comparison of the convolution layers introduced by each model (defined by the corresponding convolution implementation in PyTorch-geometric).

In order to generate the global readout of the node state, the system can take the final layer's activations for all the nodes and can apply mean pooling to create a graph representation. This representation is then used for regressing substructure counts.

| Parameter Name | Description | Values | NC | LP |
|---|---|---|---|---|
| nvertex | Number of vertices in the graph. | [128, 512] | 494 | 475 |
| p/q ratio | the ratio of in-cluster edge probability to | [1.0, 10.0] | 1.85 | 9.32 |
| | out-cluster edge probability | | | |
| avg. degree | the average expected degrees of the nodes | [1.0, 20.0] | 8.88 | 15.73 |
| feature center | the variance of feature cluster centers, | [0.0, 5.0] | 0.07 | 4.62 |
| distance | generated from a multivariate Normal | | | |
| num clusters | the number of unique node labels | [2, 6] | 4 | 4 |
| cluster size slope | the slope of cluster sizes when index- | [0.0, 0.5] | 0.08 | 0.04 |
| | ordered by size | | | |
| power exponent | the value of the power law exponent used to | [0.5, 1.0] | 0.98 | 0.55 |
| | generate expected node degrees | | | |

Table 6 can illustrate example node classification and link prediction generator values used in GraphWorld experiments.

| Parameter | | | |
|---|---|---|---|
| Name | Description | Values | Default |
| ngraphs | Number of graphs in each dataset. | [100, 500] | 394 |
| num vertices | Number of vertices in each graph | [5, 30] | 14 |
| edge prob | the edge probability of the Erdos- | [0.1, 0.75] | 0.73 |
| | Renyi graph | | |
| train prob | number of graphs in the dataset | [0.2, 0.6] | 0.21 |
| | used for training | | |

Table 7 can illustrate example graph property prediction generator values used in GraphWorld experiments.

In Tables 6 and 7, example generator parameters for task dataset generators are listed. Table 6 has parameter values for the Node Classification and Link Prediction pipelines. Table 7 has parameter values for the Graph Property Prediction pipelines. Each table contains the parameter names, their description, and their default values.

Figure can show the dropoff in performance of all unique sampled hyperparameter configurations for the GraphWorld Link Prediction Mode 1 experiment. Each configuration can have an average test metric score, averaged over each graph world location at which the configuration may be sampled. The lines in the plot can represent the ordered scores for each model, the x-axis representing the inverse percentile rank of the score. The depiction can illustrate that for most models, there may be no “elbow” or clear break between top-performing hyperparameter configuration and the next 10-20 top performing configurations.

### ADDITIONAL DISCLOSURE

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

1. A computing system, the system comprising:
one or more processors; and
one or more non-transitory computer-readable media that collectively store instructions that, when executed by the one or more processors, cause the computing system to perform operations, the operations comprising:
generating, by one or more generators, a plurality of synthetic graph datasets, wherein the plurality of synthetic graph datasets comprise structured-graph data;
training a plurality of graph models with at least a subset of the plurality of synthetic graph datasets to generate a plurality of trained graph models;
processing one or more inputs from the plurality of synthetic graph datasets with the plurality of trained graph models to generate a plurality of graph outputs;
determining a particular graph model of the plurality of graph models based on a comparison between the plurality of graph outputs; and
storing data associated with the particular graph model.

2. The computing system of claim 1, wherein the operations further comprising:
generating an evaluation representation associated with the plurality of graph models based on the plurality of graph outputs; and
providing the evaluation representation for display.

3. The computing system of claim 1, wherein each of the plurality of synthetic graph datasets comprise a realization of a parameterized probability distribution.

4. The computing system of claim 1, wherein each of the plurality of synthetic graph datasets comprise one or more training graphs, one or more training features, and one or more training labels.

5. The computing system of claim 1, wherein the one or more generators comprise one or more attributed-graph generators.

6. The computing system of claim 1, wherein the one or more generators comprise one or more label generators.

7. The computing system of claim 1, wherein each of the plurality of graph models comprise a graph neural network.

8. The computing system of claim 1, wherein the subset of the plurality of synthetic graph datasets and the one or more inputs from the plurality of synthetic graph datasets differ.

9. The computing system of claim 1, wherein the operations further comprise:
obtaining, from a user computing device, a user-input graph model;
training the user-input graph model with a first synthetic graph dataset of the plurality of synthetic graph datasets to generate a first trained graph model;
training the user-input graph model with a second synthetic graph dataset of the plurality of synthetic graph datasets to generate a second trained graph model;
processing a test portion of the plurality of synthetic graph datasets with the first trained graph model to generate a plurality of first user-model outputs;
processing the test portion of the plurality of synthetic graph dataset with the second trained graph model to generate a plurality of second user-model outputs; and
comparing the plurality of first user-model outputs and plurality of second user-model outputs.

10. The computing system of claim 9, wherein the operations further comprise:
generating evaluation data based at least in part on the plurality of first user-model outputs and plurality of second user-model outputs; and
providing the evaluation data to the user computing device.

11. The computing system of claim 1, wherein the operations further comprise:
generating comparison data based on the plurality of first user-model outputs, the plurality of second user-model outputs, and the plurality of graph outputs; and
providing the comparison data to the user computing device.

12. The computing system of claim 1, wherein the operations further comprise:
obtaining input data associated with a specific task; and
wherein training the plurality of graph models with at least the subset of the plurality of synthetic graph datasets to generate the plurality of trained graph models comprises:
training the plurality of graph models to perform the specific task.

13. The computing system of claim 12, wherein the plurality of synthetic graph datasets are generated based on the input data; and wherein the plurality of synthetic graph datasets comprise a plurality of labels associated with the specific task.

14. The computing system of claim 1, wherein training the plurality of graph models with at least the subset of the plurality of synthetic graph datasets to generate the plurality of trained graph models comprises:
training a first graph model of the plurality of graph models with a first synthetic graph dataset of the plurality of synthetic graph datasets to generate a first trained graph model;
training a first graph model of the plurality of graph models with a second synthetic graph dataset of the plurality of synthetic graph datasets to generate a second trained graph model;
training a second graph model of the plurality of graph models with a first synthetic graph dataset of the plurality of synthetic graph datasets to generate a third trained graph model;
training a second graph model of the plurality of graph models with a second synthetic graph dataset of the plurality of synthetic graph datasets to generate a fourth trained graph model; and
wherein the plurality of trained graph models comprises the first trained graph model, the second trained graph model, the third trained graph model, and the fourth trained graph model.

15. A computer-implemented method, the method comprising:
generating, by a computing system comprising one or more processors, a plurality of synthetic graph datasets, wherein the plurality of synthetic graph datasets comprise structured-graph data;
training, by the computing system, a plurality of graph models with at least a subset of the plurality of synthetic graph datasets to generate a plurality of trained graph models;
processing, by the computing system, one or more inputs from the plurality of synthetic graph datasets with the plurality of trained graph models to generate a plurality of graph outputs;
generating, by the computing system, an evaluation representation associated with the plurality of graph models based on the plurality of graph outputs; and
providing, by the computing system, the evaluation representation for display.

16. The method of claim 15, wherein the evaluation representation comprises evaluation data descriptive of node classification for the plurality of graph models.

17. The method of claim 15, wherein the evaluation representation comprises evaluation data descriptive of link prediction for the plurality of graph models.

18. One or more non-transitory computer-readable media that collectively store instructions that, when executed by one or more computing devices, cause the one or more computing devices, cause the one or more computing devices to perform operations, the operations comprising:
obtaining input data associated with a user;
generating, by one or more generators, a plurality of synthetic graph datasets based at least in part on the input data, wherein the plurality of synthetic graph datasets comprise structured-graph data;
training a plurality of graph models with at least a subset of the plurality of synthetic graph datasets to generate a plurality of trained graph models;
processing one or more inputs from the plurality of synthetic graph datasets with the plurality of trained graph models to generate a plurality of graph outputs;
generating an output representation associated with the plurality of graph models based on the plurality of graph outputs; and
providing the output representation for display.

19. The one or more non-transitory computer-readable media of claim 18, wherein the output representation comprises a graphical depiction of a feature center distance based on the plurality of graph outputs associated with the plurality of graph models.

20. The one or more non-transitory computer-readable media of claim 18, wherein the output representation comprises vector graph statistic data and hyperparameter evaluation data.
